(19) United States
(12) Patent Application Publication
(10) Pub. No.: US 2014/0282624 A1
(43) Pub. Date: Sep. 18, 2014

(54) METHOD AND PIPELINE PROCESSING SYSTEM FOR FACILITATING RESPONSIVE INTERACTION

(71) Applicant: Varian Medical Systems, Inc., Palo Alto, CA (US)

(72) Inventors: Kevin Matthew HOLT, Chicago, IL (US); Alan Carl BROOKS, Highland Park, IL (US); Stephen John HOELZER, Schaumburg, IL (US); Robert C. GEMPERLINE, Algonquin, IL (US)

(73) Assignee: Varian Medical Systems, Inc., Palo Alto, CA (US)

(21) Appl. No.: 14/216,963

(22) Filed: Mar. 17, 2014

Related U.S. Application Data
(60) Provisional application No. 61/799,178, filed on Mar. 15, 2013.

(51) Int. Cl. G06F 9/54

(52) U.S. Cl. CPC G06F 9/542
USPC 719/318

(57) ABSTRACT

The present invention is directed to a method, system, and article of manufacture of a processing pipeline with caching at one or more internal stages for altering processing steps, useful for handling responsive inspection and analysis of high energy security images. A set of particular steps useful for data, image, and X-ray analysis are presented. Several nonlinear processing pipeline architectures comprised of particular useful arrangements of processing steps and features are described: an architecture for conducting radiographic image inspections, an architecture for inspecting/analyzing multiple related imaging modalities (such as X-ray digital radiography (DR) and material discrimination (MD)) in a unified manner, and an architecture for reconstructing computed tomography (CT) X-ray images. In addition, graphical user interface (GUI) facets are described which map to pipeline parameters to control the processing steps and arrangements responsively and intuitively. The pipeline architecture and user interaction facets are applicable.

### CROSS REFERENCE TO RELATED APPLICATIONS

This application claims priority to commonly-assigned U.S. Provisional Application Ser. No. 61/799,178 entitled “Image Viewer for Security Scanning with Real-Time Interaction,” filed on 15 Mar. 2013, the disclosure of which is incorporated herein by reference in its entirety. Pursuant to 37 CFR 1.7(b), this application is hereby filed on Monday, 17 Mar. 2014, which is the next succeeding business day following the one year anniversary of the filing of Provisional Patent Application No. 61/799,178.

### TECHNICAL FIELD

The present invention relates generally to processing or inspection applications as applied to digital images and more particularly to a user interface for analyzing high energy security images and a corresponding lazy nonlinear processing pipeline to facilitate the user interface.

### BACKGROUND ART

A conventional interactive data or image viewer application displays a list of filters and operations to perform, such as enhancing operations, smoothing operations, and equalization operations. In interactively analyzing an image, for example, a user may select a sequence of operations to effectuate the image. Conventional designs typically implement this by applying each operation in an order-dependent fashion. In the conventional approach, the ability of the user to modify past operations is quite limited. Once the user has applied these operations to the image, it is difficult to modify past operations without performing backtracking to a previous state (such as via undo, multi-level undo, or reload commands), which loses any progress made since the previous state.

Conventional solutions have several distinct drawbacks. Several viewers on the market take a destructive-editing mindset. There is a long list of potential operations available to apply. The user picks one and applies it and the viewer applies the change in an order-dependent fashion. To undo it, the user must click “Undo” or manipulate a history listing. Applying operation A then operation B typically gives a different outcome compared to applying operation B then operation A. If one applies operation A and then operation B, one cannot easily repeal A by itself without undoing A and B and re-applying B, which can be cumbersome, slow, and error prone. Some filters or operations only work in particular modes, or are only useful after particular previous sequential operations. Applying operations often requires a specific “Apply” command (after setting appropriate knobs, sliders, or switches) for the operation to take effect, which involves a delay in the user seeing the results, and requires more user effort than simply changing the knobs, sliders, and switches (without an Apply step). In particular, many data inspection tasks involve quickly analyzing data from a variety of different perspectives, for which reducing any unnecessary delays or user actions can improve inspection throughput (sometimes significantly). Yet, for order-dependent operations, it can be difficult to map hardware or software sliders to these types of operations without incorporating an Apply command.

A number of inspection tasks can benefit from an improved method for interaction that is more responsive, avoids order-dependence, and eliminates unnecessary steps such as backtracking or apply commands. Examples of such inspection tasks include inspecting a container or vehicle for weapons, contraband, or other security threats; non-destructive testing (NDT) or inspection of manufactured goods for defects; or inspecting medical images for diagnosis or treatment planning.

Accordingly, it is desirable to have a flexible processing pipeline linked to order-independent user interaction facets for responsive image inspection. Additionally, while many existing applications (such as video and photo processing, and CT reconstruction) have efficient pipeline-style architectures for processing data once, those architectures are typically not optimized for quickly reprocessing the data in different ways, especially when reprocessing involves changing only a small number of order-independent facets at a time.

### SUMMARY

Embodiments of the present invention are directed to a method, system, and article of manufacture of a lazy nonlinear pipeline with a library of processing steps and associated multiple cache-points, where a particular set of processing steps are selected to serve a specified task such that the set of processing steps are arranged into a pipeline structure. The pipeline structure executes relevant processing steps in the particular set of processing steps in response to a triggering event to the pipeline. The lazy nonlinear pipeline has caching at one or more internal stages for altering processing steps, avoids unnecessary computations and facilitates inspection systems with responsive interaction; in particular for inspections systems comprising high energy X-rays or systems for image inspection for security, NDT, or medical applications (e.g. medical image viewing and manipulation). A set of particular steps useful for data, image, and X-Ray analysis is presented. Several nonlinear processing pipeline architectures comprised of particular useful arrangements of processing steps and features are described: an architecture for conducting radiographic image inspections; an architecture for inspecting/analyzing multi-spectral data (such as X-ray scans at multiple energies, which may also comprise both digital radiography (DR) and material discrimination (MD) data, or multiple imaging modalities (such as combining two or more of X-rays, MRI, ultrasound, infrared, mm wave, THz imaging, or visible light)) in a unified manner; and an architecture for reconstructing computed tomography (CT) X-ray images. In addition, order-independent graphical user interface (GUI) facets are described which map to pipeline parameters to control the processing steps and arrangements responsively and intuitively. The pipeline architecture and user interaction facets are applicable generally to a wide range of responsive signal processing, imaging, analysis, and inspection applications.

Embodiments of processing pipeline in general support any pipeline structure (linear or nonlinear) where a number of processing steps can be described in a directed graph. Often it can be convenient if each step in the pipeline only need exchange status messages with the pipeline framework or with other steps in the pipeline that it will directly read data from or send data to, and not exchange status messages with steps that are far away. While this is not a requirement for the invention per se, embodiments of the present invention are quite conducive to using steps that are nicely factored into clean steps with relatively simple input/output rules and minimal inter-step programming dependencies.

The pool of available steps is arranged from different embodiments to serve different pipeline processing purposes. Graphical user interface (GUI) embodiments are provided with a unified set of facet controls for controlling the processing steps and arrangements in the processing pipeline architectures. Some suitable applications of the user interface include the following: inspection of high energy security images of conveyances such as trucks, trains, cars, cargo and shipping containers; performing non-destructive testing (NDT) inspections of industrial parts; analyzing medical images; analyzing fluoroscopic data (including X-ray video data); or analyzing a CT image.

Broadly stated, the processing pipeline invention is a method for data processing, comprising performing an operation by dividing the operation into a plurality of processing steps; creating a pipeline by arranging the plurality of processing steps into a pipeline structure, the plurality of processing steps selected to accomplish the operation; responding to an event by determining a subset of steps from the plurality of processing steps that are relevant to the event; and executing the pipeline by running processing steps in the pipeline structure that are relevant to the event.

Advantageously, embodiments of a nonlinear pipeline with multiple cache-points permit the ability to refresh the pipeline responsively (often in real time on commodity hardware) without recalculating every branch.

The structures and methods of the present invention are disclosed in the detailed description below. This summary does not purport to define the invention. The invention is defined by the claims. These and other embodiments, features, aspects, and advantages of the invention will become better understood with regard to the following description, appended claims and accompanying drawings.

### BRIEF DESCRIPTION OF THE DRAWINGS

The invention will be described with respect to specific embodiments thereof, and reference will be made to the drawings, in which:

FIG. 1 is a block diagram illustrating an exemplary interactive computer system for handling images upon which a system embodiment of the invention may be implemented in accordance with various embodiments of the present invention.

FIG. 2 is a block diagram illustrating the second system embodiment of a cloud computing environment accessible by cloud clients for a user conducting inspection of and interacting with images in accordance with various embodiments of the present invention.

FIG. 3 is a software system diagram illustrating the image viewer engine for responsive inspection and interaction in accordance with various embodiments of the present invention.

FIG. 4A is a block diagram illustrating a first embodiment of the pipeline engine as an integrated pipeline engine in accordance with various embodiments of the present invention; and FIG. 4B is a block diagram illustrating a second embodiment of the pipeline engine as a plugin pipeline engine in accordance with various embodiments of the present invention.

FIG. 5A is a block diagram illustrating a first embodiment of a pipeline structure implemented with a linear pipeline structure by which the pipeline engine executes a series of processing steps linearly in accordance with one embodiment; FIG. 5B is a block diagram illustrating a second embodiment of the pipeline structure implemented with a nonlinear processing pipeline structure and more particularly a loop pipeline structure with a single input and a single output in accordance with one embodiment; FIG. 5C is a block diagram illustrating a third embodiment of a pipeline structure implemented with a nonlinear pipeline structure and more particularly a directed acyclic graph (DAG) pipeline structure with a single input and a single output in accordance with one embodiment; FIG. 5D is a block diagram illustrating a fourth embodiment of the pipeline structure implemented with a DAG pipeline structure with progressive steps in accordance with one embodiment; and FIG. 5E is a block diagram illustrating a fifth embodiment of a pipeline structure implemented with a DAG pipeline structure with multiple inputs and multiple outputs in accordance with one embodiment.

FIG. 6A is a block diagram illustrating one exemplary embodiment of processing step connections to show how steps may be connected in relation to each other in accordance with various embodiments of the present invention; FIG. 6B is a block diagram illustrating an example of a branched portion of a pipeline; this example pipeline equalizes an image based on a filtering step and a dynamic range analysis step in accordance with various embodiments of the present invention; and FIG. 6C is a block diagram illustrating a simple example of a pipeline structure where each step performs an arbitrary mathematical function in accordance with various embodiments of the present invention.

FIG. 7 is a block diagram illustrating an example of a main software loop that controls pipeline refreshes in accordance with various embodiments.

FIG. 8 is a simplified flow diagram illustrating a pipeline refresh process in accordance with various embodiments of the present invention.

FIG. 9 is a simplified flow diagram illustrating the propagation of status flags in accordance with various embodiments of the present invention.

FIG. 10 is a flow diagram illustrating the processing flow associated with requesting output from a step in accordance with various embodiments of the present invention.

FIGS. 11A-E are block diagrams illustrating example operational flow in accordance with various embodiments of the present invention.

FIGS. 12A-D are flow diagrams illustrating the propagation of status flags with progressive step support in accordance with various embodiments of the present invention.

FIG. 13 is a flow diagram illustrating the processing flow associated with requesting output from a step with progressive step support in accordance with various embodiments of the present invention.

FIGS. 14A-E are block diagrams illustrating example operational flow with synchronous progressive steps in accordance with various embodiments of the present invention; and FIGS. 14F-M are block diagrams illustrating examples of simplified pipeline operational flow with abridgments in accordance with various embodiments of the present invention.

FIG. 15 is a flow diagram illustrating a pipeline process with asynchronous support in accordance with various embodiments of the present invention.

FIGS. 16A-B are flow diagrams illustrating the propagation of status flags with progressive and asynchronous support in accordance with various embodiments of the present invention.

FIG. 17 is a flow diagram illustrating the pipeline architecture for an asynchronous result notification in accordance with various embodiments of the present invention.

FIGS. 18A-P are block diagrams illustrating example operational flow with thrifty asynchronous steps in accordance with various embodiments of the present invention.

FIG. 19 is a flow diagram illustrating a pipeline optimized for inspection of radiographic images in accordance with various embodiments of the present invention.

FIG. 20 is a flow diagram illustrating a MD-capable pipeline for digital radiography and material discrimination in accordance with various embodiments of the present invention.

FIG. 21 is a flow diagram illustrating a radiography pipeline for digital radiography, material discrimination, and content analysis in accordance with various embodiments of the present invention.

FIG. 22 is a flow diagram illustrating a radiography pipeline for material discrimination peeling in accordance with various embodiments of the present invention.

FIG. 23 is a flow diagram illustrating a radiography pipeline with the object analysis step assembly in accordance with various embodiments of the present invention.

FIG. 24 is a flow diagram illustrating a radiography pipeline with the composite step assembly in accordance with various embodiments of the present invention.

FIG. 25 is a flow diagram illustrating a CT linear pipeline in accordance with various embodiments of the present invention.

FIG. 26 is a first illustration of a radiography viewer graphical user interface that uses a pipeline in accordance with various embodiments of the present invention.

FIG. 27 is a second illustration of a radiography viewer graphical user interface that shows adjusting edge strength control and reset in accordance with various embodiments of the present invention.

FIG. 28 is an illustration of a radiography viewer graphical user interface with material discrimination and content analysis in accordance with various embodiments of the present invention.

### DETAILED DESCRIPTION

A description of structural embodiments and methods of the present invention is provided with reference to FIGS. 1-28. It is to be understood that there is no intention to limit the invention to the specifically disclosed embodiments but that the invention may be practiced using other features, elements, methods and embodiments. Like elements in various embodiments are commonly referred to with corresponding reference numerals.

The following definitions may apply to some of the processing pipeline elements, such as processing steps; some of the user interface elements, such as facet controls; and the mapping between facets and the processing pipeline; and are described with regard to some embodiments of the invention. These terms may likewise be expanded upon herein.

Advanced DRM—DRM operations that are not merely point-wise functions of pixel values. Typically, Advanced DRM is used to locally compress intensity values for improved dynamic range. Techniques for Advanced DRM include adaptive histogram equalization, contrast-limited adaptive histogram equalization (CLAHE), tone mapping approaches, or the method of 2008/0226,167.

Apply Command—refers to a command that commits an order-dependent operation to the current data state, so that all future operations begin with the data set with this operation already applied. Apply commands are common (and typically an integral component that cannot be easily omitted) in prior art, but they are not necessary in this invention (and are thus typically avoided when using this invention).

Backtracking—refers to an undoing of one or more recent activities by a user, which is a technique common across user interfaces in a wide variety of applications. When used with facet controls, backtracking moves the control state (typically slider location or toggle value) from its current state to a previous state. When used with order-dependent operations, backtracking undoes the operation, typically by keeping a complete history of all operations that have been applied to a data set, reloading the data, and repeating all operations older than the backtracking target. Backtracking one activity is called “Undo”. Backtracking several activities is called multi-level undo. Backtracking all activities (essentially, discarding all activities and starting anew) is typically called “Reload” or “Revert”.

Black Level is the pixel value that maps to the “black” end of the color range for image display. Similarly, White Level refers to the pixel value that maps to the “white” end of the color range for image display. When using standard grayscale display, the coloring ranges from black to white, the “black” end is literally black, and the “white” end is literally white. When using alternate color schemes, the “black” and “white” limits may actually correspond to some other visible color.

Color Scheme—refers to a configuration that determines how to form pseudocolor images.

Conditioning—refers to applying some smoothing filters to the input images, typically to reduce noise or artifacts prepare data for other upcoming steps. Common choices include linear filters (which include box, Gaussian, generic low-pass FIR or IIR), median filters, or edge-preserving smoothing filters.

DR (Digital Radiography)—an X-ray imaging technique analogous to film but using electronic image capture and display.

DR Filter—refers to applying one or more smoothing filters, sharpening filters, or more general image restoration techniques for deblurring, denoising, or the like.

DRM (dynamic range manipulation)—refers to operations that manipulate the range of intensities seen by a user. Typically, DRM aims to compress dynamic range (typically expanding local contrast), expand dynamic range (to better see global image context at the expense of local contrast), target a specific intensity range, or apply some other transformation either to improve inspection ability (or even just for aesthetic reasons).

DRM Mix—refers to blending data from multiple DRM steps, typically by a weighted average (i.e. linear sum) where the weights are adjustable processing parameters.

DR step—from multi-spectral data, refers to extracting a single image by either extracting a single spectrum DR image from the multi-spectrum set or by forming a virtual single-spectrum DR image by combining images from several spectra.

Edge Detect—refers to creating an edge-image by applying standard edge-detection or enhancement techniques. Hard edge detection methods (often simply called edge detection) generally include some operator or filter (such as the Roberts, Sobel, Prewitt, directional derivative, Laplacian, Laplacian-of-Gaussian, or Canny operators) followed by a thresholding operation and sometimes a line-detection or edge-localization step, resulting in a binary classification of each pixel (as edge or not). Soft edge detection methods (sometimes called edge enhancement) are similar but skip the thresholding step or replace it with a clamping operation. Edge detection methods may also comprise nonlinear transformations to condition their input and/or to normalize their output.

Facet—refers to an order-independent attribute of data processing (from the pipeline's perspective) or rendering (from the user's perspective). In contrast to a step, which applies some specific operation, a facet describes the phenomenological result of applying one or more steps.

Highlighting Rule—refers to the highlighting rule selected by the user, which controls how detected objects are displayed.

Inspection Region—the set of pixels that are to be interrogated by a property analysis step. Typically this is either the entire image, the portion of the image visible on-screen, or a portion of an image contained in an ROI (where the ROI could be either automatically determined or manually drawn).

Interest Map—refers to a list of identified portions of the data that are interesting for some reason (typically because they are suspicious). An interest map may be described by a number of techniques, including a mask, soft mask, or shape-based ROI.

Interest Map List—refers to a list of interest maps, which may be described by an array of masks, soft masks, or shape-based ROIs, or by other techniques such as integer-valued label images.

Lazy Processing Pipeline—refers to a pipeline with one or more (typically several) caches at various internal stages of the pipeline, which are leveraged to avoid re-computing up-to-date results during pipeline refreshes. In particular, a lazy pipeline uses cached values for any steps with an up-to-date cache rather than calculating new values for that step, and it also avoids steps or branches (whether cached or up-to-date or not) that do not contribute to the desired pipeline output.

MCT (material calibration table)—this table describes the correspondence between different material signatures (that can be measured from the multi-spectral projection data) and material composition. For additional materials on this feature, see U.S. published patent application no. 2010/0310,175, assigned to the common assignee.

MD (Material Discrimination)—refers to a technique for estimating material type (and in some cases also a confidence of that estimate) from multi-spectral X-ray projection data.

MD Filter—refers to applying one or more filters to improve MD results. Typically this involves smoothing or denoising material type estimates. This may also comprise incorporating confidence information when calculating improved material type estimates. This may also comprise calculating new confidence information to reflect confidence in the improved material estimates.

MD step—refers to calculating estimates for material type and, in some embodiments, also confidence information for each of these estimates. For additional details, see U.S. published patent application no. 2010/0310,175 and U.S. published patent application no. 20130101156, which are incorporated by reference in their entireties.

Merge Interest Map Lists—refers to merging two lists of interest maps

Multi-Spectral Projection Data—refers to a set of images of the same object taken with different imaging source spectra, different imaging modalities, and/or different detector spectral sensitivities. For additional information on this feature, see U.S. published patent application no. 2010/0310,042, assigned to the common assignee.

Nonlinear Processing Pipeline—“nonlinear pipeline” means the pipeline may have branches, multi-input steps, multi-output steps, loops, multiple pipeline inputs, and/or multiple pipeline outputs.

Object Analysis—refers to performing analysis on data (such as transmission data and/or MD data) to identify interesting pixels or regions, and/or additional information or decisions about those pixels or regions. This step can perform a number of very different algorithms, including hidden-object detection (For more information, see U.S. non-provisional patent application entitled “Method and Apparatus Pertaining to Identifying Objects of Interest in a High-Energy Image,” Ser. No. 13/676,534, invented by Kevin M. Holt, filed on 14 Nov. 2012, and the corresponding PCT application no. PCT/US13/70118, filed on 14 Nov. 2013; and a co-pending PCT patent application entitled “Apparatus and Method for Producing Anomaly Image,” PCT/US2014/028258, invented by Kevin M. Holt, filed on 14 Mar. 2014, owned by the common assignee, and a provisional application entitled “A Method for Detecting Anomalies in Cargo or Vehicle Images,” Ser. No. 61/783,285, invented by Kevin M. Holt, filed on 14 Mar. 2013, the disclosures of which are incorporated by reference herein in their entireties), anomaly-object detection (For more information, see U.S. non-provisional patent application entitled “Method and Apparatus Pertaining to Identifying Objects of Interest in a High-Energy Image,” Ser. No. 13/676,534, invented by Kevin M. Holt, filed on 14 Nov. 2012, and the corresponding PCT application no. PCT/US13/70118, filed on 14 Nov. 2013; and a co-pending PCT patent application entitled “Apparatus and Method for Producing Anomaly Image,” PCT/US2014/028258, invented by Kevin M. Holt, filed on 14 Mar. 2014, owned by the common assignee, and a provisional application entitled “A Method for Detecting Anomalies in Cargo or Vehicle Images,” Ser. No. 61/783,285, invented by Kevin M. Holt, filed on 14 Mar. 2013, the disclosures of which are incorporated by reference herein in their entireties), medical computer-aided diagnosis (CAD) algorithms, or other generic computer vision or threat detection algorithms.

Pan/Zoom—refers to a viewer's current pan and zoom positions (typically controlled by mouse, keyboard, touchscreen, edit box, joystick, etc.)

Processing Step (or just “Step”)—refers to a processing step which can be a computational step, a computer operation, a sorting operation, a memory transfer operation, a functional step, a functional component, a sub-function, an operation, an act, or a mathematical function in a pipeline architecture or a pipeline engine for processing images.

Property Estimator—calculates things such as mass, area, volume, or other statistics for a particular region.

Pseudocolor—refers to generating a color image from data that is not inherently in color. This is particularly useful for MD rendering (see U.S. published application 2010/0310,175, assigned to the common assignee for details) but can also be useful for other applications, including for DR viewing or for highlighting threats.

Relevant and Irrelevant Steps—Relative to a particular pipeline output, a particular processing step is “irrelevant” if it can be asserted that changing the output of the particular step would have no bearing on the particular pipeline output, even if all steps were recalculated anew. If a particular step cannot be asserted to be irrelevant to the particular pipeline output, the particular step is considered relevant to the particular pipeline output. Relative to some triggering event, a processing step is considered relevant to the triggering event if the triggering event affects one or more steps that are relevant to some pipeline output of interest.

Simple DRM—apply a point-wise mapping to the pixel values to adjust their dynamic range. Often this is a simple linear windowing, f(x)=clamp((x-BlackLevel)/(WhiteLevel−BlackLevel)) to [0,1]. It may also include a gamma adjustment, where DataOut[pixel]=DataIn[pixel]̂gamma. It could also be performed (instead or in addition) by global histogram equalization or other nonlinear transformations.

FIG. 1 is a block diagram illustrating an exemplary interactive computer system for handling security images upon which a system embodiment of the invention may be implemented. A computer system 10 includes a central processing unit (CPU) 12 and a graphics processing unit (GPU) for processing information. The CPU 12 and the GPU 14, collectively processors, are coupled to a bus 16 or other communication medium for sending and receiving information. The processors 12, 14 may be an example of the processors 12, 14 of FIG. 1, or other equivalent processors that are used to perform various functions described herein. In some cases, the computer system 10 may be used to implement the CPU 12 and the GPU 14 as a system-on-a-chip integrated circuit. The computer system 10 also includes a main memory 18, such as a random access memory (RAM) or other dynamic storage device, coupled to the bus 16 for storing information and instructions to be executed by the CPU 12 and the GPU 14. The main memory 18 also may be used for storing temporary variables or other intermediate information during execution of instructions by the CPU 12 and the GPU 14. The computer system 10 further includes a read only memory (ROM) 20 or other static storage device coupled to the bus 16 for storing static information and instructions for the CPU 12 and the GPU 14. A data storage device 22, such as a magnetic disk (e.g., a hard disk drive), an optical disk, or a flash memory, is provided and coupled to the bus 16 for storing information and instructions. The computer system 10 (e.g., desktops, laptops, tablets) may operate on any operating system platform using Windows® by Microsoft Corporation, MacOS or iOS by Apple, Inc., Linux, UNIX, and/or Android by Google Inc.

The computer system 10 may be coupled via the bus 16 to a display 24, such as a flat panel for displaying information to a user. An input device 26, including alphanumeric, pen or finger touchscreen input, other keys, or voice activated software application (also referred to as intelligent personal assistant or a software application that uses a natural language user interface) is coupled to the bus 16 for communicating information and command selections to the processor 12. Another type of user input device is cursor control 28, such as a mouse (either wired or wireless), a trackball, a laser remote mouse control, or cursor direction keys for communicating direction information and command selections to the CPU 12 and the GPU 14 and for controlling cursor movement on the display 24. This input device typically has two degrees of freedom in two axes, a first axis (e.g., x) and a second axis (e.g., y), that allows the device to specify positions in a plane.

The computer system 10 may be used for performing various functions (e.g., calculation) in accordance with the embodiments described herein. According to one embodiment, such use is provided by the computer system 10 in response to the CPU 12 and the GPU 14 executing one or more sequences of one or more instructions contained in the main memory 18. Such instructions may be read into the main memory 16 from another computer-readable medium, such as storage device 22. Execution of the sequences of instructions contained in the main memory 18 causes the CPU 12 and the GPU 14 to perform the processing steps described herein. One or more processors in a multi-processing arrangement may also be employed to execute the sequences of instructions contained in the main memory 18. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the CPU 12 and the GPU 14 for execution. Common forms of computer-readable media include, but are not limited to, non-volatile media, volatile media, transmission media, a floppy disk, a flexible disk, a hard disk, magnetic tape, any other magnetic medium, a CD-ROM, a DVD, a Blu-ray Disc, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read. Non-volatile media includes, for example, optical or magnetic disks, such as the storage device 22. Volatile media includes dynamic memory, such as the main memory 18. Transmission media includes coaxial cables, copper wire, and fiber optics. Transmission media can also take the form of acoustic or light waves, such as those generated during radio wave and infrared data communications.

Various forms of computer-readable media may be involved in carrying one or more sequences of one or more instructions to the CPU 12 and the GPU 14 for execution. For example, the instructions may initially be carried on a magnetic disk of a remote computer. The remote computer can load the instructions into its dynamic memory and send the instructions over a communication link 30. The computer system 10 includes a communication interface 30 for receiving the data on the communication link 32. The bus 16 carries the data to the main memory 18, from which the CPU 12 and the GPU 14 retrieve and execute the instructions. The instructions received by the main memory 18 may optionally be stored on the storage device 22 either before or after execution by the CPU 12 and the GPU 14.

In one embodiment, the RAM volatile memory 18 is configured to store and run an image viewer engine 28 (also referred to as image viewer software engine). The image viewer can be stored and executed from a variety of sources, including the ROM non-volatile memory 20, the data storage device 22, as well as execution by the CPU 12 or the GPU 14.

The communication interface 30, which is coupled to the bus 16, provides a two-way data communication coupling to the network link 32 that is connected to a communication network 34. For example, the communication interface 30 may be implemented in a variety of ways, such as an integrated services digital network (ISDN), a local area network (LAN) card to provide a data communication connection to a compatible LAN, a Wireless Local Area Network (WLAN) and Wide Area Network (WAN), Bluetooth, and a cellular data network (e.g. 3G, 4G). In wireless links, the communication interface 30 sends and receives electrical, electromagnetic or optical signals that carry data streams representing various types of information.

The communication link 32 typically provides data communication through one or more networks to other devices. For example, the communication link 32 may provide a connection through the communication network 34 to an image system 36 for acquiring data or imagery in one location and analyzing it locally or in remote locations such as trailers, buildings, trucks, trains, cars, or any remote mobile location. The image data streams transported over the communication link 28 can comprise electrical, electromagnetic or optical signals. The signals through the various networks and the signals on the communication link 30 and through the communication interface 30, which carry data to and from the computer system 10, are exemplary forms of carrier waves transporting the information. The computer system 10 can send messages and receive data, including image files and program code, through the network 34, the communication link 32, and the communication interface 30.

Alternatively, image files can be transported manually through a portable storage device like a USB flash drive for loading into the storage device 22 or main memory 18 of the computer system 10, without necessarily transmitting the image files to the communication interface 30 via the network 34 and the communication link 32.

FIG. 2 is a block diagram illustrating the second system embodiment of a cloud computing environment 38 accessible by cloud clients 40 for a user conduct inspection and interaction of security images. A cloud computer 42 runs a cloud operating system 44, which may include other additional cloud computers, for data communications. The cloud clients 40 communicate with the cloud computer 42 through the network 34, either wirelessly or via a wired connection. The cloud clients 40 are broadly defined to include, but not to be limited to, desktop computers, mobile devices (including smartphones and tablet computers like iPad), notebook computers, SmartTVs, and SmartAutos. A variety of mobile devices are applicable to the present invention including mobile phones, smartphones like iPhones, tablet computers like iPads, and browser-based notebook computers like Chromebooks, with a processor, a memory, a screen, and connection capabilities of Wireless Local Area Network (WLAN) and Wide Area Network (WAN). The mobile device is configured with a full or partial operating system (OS) software, which provides a platform for running basic and advanced software applications. The mobile device functioning as the cloud client 40 accesses the cloud computer 42 through a web browser.

In this embodiment, the cloud computer 42 (also referred to as a web/HTTP server) comprises a processor 46, an authentication module 48, a virtual storage of medical images 50, a RAM 52 for executing a cloud operating system 44, virtual clients 54, and the image viewer engine 28. The cloud operating system 44 can be implemented as a module of automated computing machinery installed and operating on one of the cloud computers. In some embodiments, the cloud operating system 44 can include several submodules for providing its intended functional features, such as the virtual clients 54, the image viewer engine 28, and the virtual storage 50.

In an alternate embodiment, the authentication module 48 can be implemented as an authentication server. The authentication module 48 is configured to authenticate, and grant permission, whether the cloud client 40 is an authorized user to access one or more medical images associated with a particular patient in the virtual storage 50. The authentication module (or authentication server) 30 may employ a variety of authentication protocols to authenticate the user, such as a Transport Layer Security (TLS) or Secure Socket Layer (SSL), which are cryptographic protocols that provide security for communications over networks like the Internet.

An operator would be able to select data or images, which may be stored in the virtual storage 50 of the cloud computer 42 in the cloud computing environment 38. The cloud client 40, such as a smartphone or a tablet computer, is capable of accessing the virtual storage 50 in the cloud computer 42 through the network 30 and displays security images on the display of the cloud client 40. An operator would be able to view and edit data or images from a remote location on a handheld device.

FIG. 3 is a software system diagram illustrating the image viewer engine 28 for responsive security inspection and interaction. The image viewer engine 28 comprises a pipeline engine 56, a module 58, a communication/network interface 60, an optional data acquisition module 62, a memory/storage module 64, a display module 66 and a bus 68. The pipeline engine 56 is configured to process or refresh steps or branches in the pipeline for efficient processing of high energy security images. The viewer control/user interface module 58 is configured to control a set of controls like sliders and toggles of a user interface between the pipeline engine and a computer display. The communication/network interface 60 is configured to send and receive data between the image viewer engine 28 of the computer engine 10 and a computer network. The data acquisition module 62 is configured to receive high energy security images into the image viewer engine 28 for processing. Alternatively, the high energy security images may be obtained from sources that are communicated to the image viewer engine 28 through the communication/network interface 60. The memory/storage module 64 is configured to store all types of data, including high energy security images, for subsequent retrieval and processing. The display module 68 is configured to display the high energy security images on the computer display 24 for viewing and processing by the image viewer engine 28.

The pipeline engine 56, the module 58, the communication/network interface 60, the optional data acquisition module 62, the memory/storage module 64, and the display module 66 communicate with each other bidirectionally through the bus 68. The various engine and modules in the image viewer engine 28 are intended as one embodiment for illustration purposes in which additional software subsystems can be added, removed, altered or integrated as part of the constructs in the image viewer engine 28. The bus 68 provides one embodiment in communication between the various engines and modules in the image viewer engine 28, as various other forms of communication connections are feasible within the contemplation of the present invention.

### I. Pipeline Operating Environments

In a first aspect of the invention, some embodiments are directed to a nonlinear processing pipeline with caching at one or more internal stages, where “nonlinear pipeline” means the pipeline may have branches, multi-input steps, multi-output steps, loops, multiple pipeline inputs, and/or multiple pipeline outputs. Additionally the pipeline supports lazy refreshes, so when refreshing the pipeline, the calculation of some pipeline steps or branches may be skipped if they currently have no contribution to the pipeline's output, or if their contribution to the pipeline's output would be unchanged since the previous refresh.

Embodiments of the present invention support any pipeline structure, linear or nonlinear, where a number of processing steps can be described in a mathematical graph.

The pipeline operating environments may also consider other factors such as pipeline utilization and pipeline latency. Pipeline utilization refers to the pipeline's capability to process new input data in earlier steps while working on order data on later steps such that, for example, if all steps take the same amount of time to run, then all steps would be processing something if new data came in at that rate.

### General Concepts of Pipeline Frameworks

Processing Step. The pipeline framework links together a number of processing steps. These can do things like read a file, apply a filter, toggle between two inputs, linearly combine two inputs, scale or zoom, crop, apply a transform, pre-calculate some statistics, perform dynamic range adjustments, or perform some physics calculations. These steps may each be present as different software modules that are either statically linked (i.e. arranged at compile time) or dynamically linked (i.e. arranged as plugins that are linked upon initializing the pipeline software) or loosely coupled (i.e. steps that are linked via a remote communication protocol). Or these steps may be tightly coupled together in a single large software module. Or the steps may be linked remotely with some steps running on different processors or in different locations with data/status streaming over a remote data link (network or otherwise).

In some embodiments, many steps are single-input/single-output, but in some cases a step may also have no inputs, multiple inputs, no outputs, or multiple outputs. See FIG. 6A for a generalized step.

Pipeline. FIG. 4A is a block diagram illustrating a first embodiment of the pipeline engine 56 as an integrated pipeline engine 70. The integrated pipeline engine 70 comprises one monolithic piece of code that incorporates a plurality of steps, where the plurality of steps are written as one comprehensive set of code or the plurality of steps are not clearly delineated separately between a first step 72, a second step 74, a third step 76, a fourth step 78 and so on.

FIG. 4B is a block diagram illustrating a second embodiment of the pipeline engine 56 as a plugin pipeline engine 80. The architecture in the plugin pipeline engine 80 is designed with separate pipeline framework components, a first plugin step 82, a second plugin step 84, a third plugin step 86, a fourth plugin step 88. The plugin pipeline engine 80 is configured to manage how plugin steps 82, 84, 86, 88 are connected, how data and status messages are passed around between the plugin steps 82, 84, 86, 88, and to determine how the pipeline components 82, 84, 86, 88 that actually perform the computational operations are organized into separate plugin software modules. These plugins 82, 84, 86, 88 can be statically linked or dynamically linked into the plugin pipeline engine 78. Alternatively, the plugins 82, 84, 86, 88 can also communicate directly with each other and between the plugins 82, 84, 86, 88 (e.g., DAG-like communication channels).

The pipeline framework 70 or 80 links together a number of processing steps, such as steps 72, 74, 76, 78, and processing steps 82, 84, 86, 88. Some exemplary functions of the processing steps 72, 74, 76, 78, 82, 84, 86, 88 include reading a file, applying a filter, toggling between two inputs, linearly combining two inputs, scaling or zooming, pre-calculating some statistics, performing dynamic range adjustments, or performing some physics calculations. Each of the processing steps 72, 74, 76, 78, 82, 84, 86, 88 may be present as different software modules that are either statically linked (i.e., arranged at compile time) or dynamically linked (i.e., arranged as plugins that are linked upon initializing the pipeline software). Alternatively, these steps may be combined together in a single large software module.

Embodiments of the present invention also support “step assemblies”, which are pre-arranged configurations of steps. The assembly itself can be treated as a step to the rest of the pipeline, i.e. a processing step with one or more inputs and one or more outputs, though inside the assembly are a number of lower-level steps, encapsulated within the step assembly. Alternatively, once a step assembly is incorporated into a pipeline, the pipeline might treat each step in the step assembly in the same way as every other step in the pipeline (so that step assemblies are used more for organizing steps than for the actual pipeline data and status flows). The latter is our preferred approach.

The processing steps of the present invention support various pipeline structures, linear and nonlinear, that can be described in computational graphs, logical graphs, or mathematical graphs. Various pipeline structures are described with respect to FIG. 5A-5E with pipeline steps disposed between one or more inputs routing to one or more outputs, where each pipeline step represents a particular computational function.

FIG. 5A is a block diagram illustrating a first embodiment of a pipeline structure implemented with a linear pipeline structure 90 by which the pipeline engine 56 executes a series of processing steps linearly. The pipeline engine 56 is configured to execute processing steps 92, 94, 96, 98, 100, 102 sequentially. One suitable use of the linear pipeline structure 90 is for providing refreshed outputs efficiently in response to parameter changes without re-running every step in the pipeline. The pipeline functionality allows fewer calculations to be run when the parameter change affects steps close to the pipeline's output, for example.

FIG. 5B is a block diagram illustrating a second embodiment of the pipelines structure implemented with a nonlinear processing pipeline loop structure 104 with a single input 106 and a single output 108. The pipeline engine 56 is configured to process the nonlinear processing pipeline loop structure 104 through a path with steps 106, 108, 110, 112, 114, 116. The nonlinear processing pipeline loop structure 104 includes a pipeline loop, which routes from the output of the step 116 to the input of the step 114 by a routing link 118.

FIG. 5C is a block diagram illustrating a third embodiment of a pipeline structure implemented with a nonlinear Directed Acyclic Graph (DAG) pipeline structure 120 with a single input (or step) 122 and a single output (or step) 124 where the input data is processed through multiple paths. The nonlinear pipeline structure 120 has multiple data flows in routing the input 122 to the output 124. In a first data flow path, the pipeline engine 56 is configured to process the pipeline structure 120 linearly from source step 122, through a step 126, a step 128, a step 130, a step 132, and a step 134 to the output step 124. In a second data flow path, the pipeline engine 56 is configured to process the pipeline structure 120 nonlinearly from step 128, which jumps to the output 124 by a routing link 136. In a third path, the pipeline engine 56 is configured to process the pipeline structure 120 nonlinearly by jumping from the input step 122 to a step 138 via a routing link 140, a step 142, which connects to the step 132 via a routing link 144. In a fourth path, the pipeline engine 56 is configured to process the pipeline structure 120 from step 138 to the step 134 via a routing link 146. The nonlinear DAG pipeline structure 120 with the single input 122 and the single output 124 is suitable for simple processing and viewing applications.

FIG. 5D is a block diagram illustrating a fourth embodiment of a pipeline structure implemented with a nonlinear DAG structure 148 with progressive steps 150, 152 where in the input data is processed through multiple paths. Each of the progressive steps 150, 152 provides functional loop-back operations. The pipeline engine 56 is configured to process the nonlinear DAG structure 148 from the input step 154 to the output step 152 through four paths as illustrated in this embodiment. In a first path, the pipeline engine 56 is configured linearly to process of the nonlinear DAG structure 148 through the steps 154, 156, 158, 160, 150, 162, 152. In a second path, the pipeline engine 56 is configured nonlinearly to process the nonlinear DAG structure 148 through the steps 154, 156, 158, 152 (via a routing link 164). In a third path, the pipeline engine 56 is configured nonlinearly to process the nonlinear DAG structure 148 through the steps 154, 166 (via a routing link 168), 170 (via a routing link 172), 150 (via a routing link 174), 162, 152. In a fourth path, the pipeline engine 56 is configured nonlinearly to process the nonlinear DAG structure 148 through the steps 154, 166, 162 (via a routing link 176), 152.

FIG. 5E is a block diagram illustrating a fifth embodiment of a pipeline structure implemented with a nonlinear DAG structure 178 with multiple inputs 180, 182, 184 and multiple outputs 186, 188 where the data inputs are routed through multiple paths to multiple outputs. The nonlinear DAG structure 178 may be adopted for more advanced applications where the capability of a multi-input/multi-output combination can be powerful. Multi-input pipelines can be especially powerful when mixing multiple data sources, such as many modalities or multiple spectra. Multi-output pipelines can be powerful when there are multiple rendering or user feedback mechanisms—such as displaying a visual image, displaying summary statistics, performing automated segmentation, or performing automated threat detection.

Data inputs 180, 182, 184 of the nonlinear DAG structure 178 are routed to the outputs 186, 188. In a first path, the pipeline engine 56 is configured to process the nonlinear DAG structure 178 from the first input step 180 to the first output step 186 through steps 190, 192. In a second path, the pipeline engine 56 is configured to process the nonlinear DAG structure 178 from the first input step 180 to the first output step 186 through step 190, step 194 (via a routing link 196), step 198, step 200, step 202, step 204. In a third path, the pipeline engine 56 is configured to process the nonlinear DAG structure 178 from the first input step 180 to the first output step 186 through steps 190, 194 (via the routing link 196), 204 (via a routing link 208). In a fourth path, the pipeline engine 56 is configured to process the nonlinear DAG structure 178 from the first input step 180 to the second output step 188 through steps 190, 194 (via the routing link 196), 198, 200, 202.

In a fourth path, the pipeline engine 56 is configured to process nonlinear DAG structure 178 from the second input step 182 through steps 206, 194, 198, 200, 202, 204 to the first output step 186. In a fifth path, the pipeline engine 56 is configured to process nonlinear DAG structure 178 from the second input step 182 through steps 206, 194, 204 (via the routing link 208), to the first output step 186. In a sixth path, the pipeline engine 56 is configured to process nonlinear DAG structure 178 from the second input step 182 to the first output step 186 through the steps 210 (via a routing link 212), 214 (via a routing link 216), 200 (via a routing link 218), 202, 204. In a seventh path, the pipeline engine 56 is configured to process nonlinear DAG structure 178 from the second input step 182 to the first output step 186 through steps 210 (via the routing link 212), 202 (via a routing link 220), 204. In an eighth path, the pipeline engine 56 is configured to process the nonlinear DAG structure 178 from the second input step 182 to the second output step 188 through steps 206, 194, 198, 200, 202.

In a ninth path, as for the third input step 184 to the first output step 186, the pipeline engine 56 is configured to process nonlinear DAG structure 178 through steps 210, 214 (via a routing link 216), 200 (via a routing link 218), 202, 204. In a tenth path, the pipeline engine 56 is configured to process nonlinear DAG structure 178 from the third input step 184 through 210, 202 (via the routing link 220), 204 to the first output step 186. In an eleventh path, the pipeline engine 56 is configured to process nonlinear DAG structure 178 from the third input step 184 to the second output step 188 through the steps 210, 214 (via a routing link 216), 200 (via the routing link 218), 202. In a twelfth path, the pipeline engine 56 is configured to process nonlinear DAG structure 178 from the third input step 184 through the steps 210, 202 (via the routing link 220) to the second output step 188.

In some embodiments, each step in the pipeline structures 90, 104, 120, 148, 178 communicates with its immediate neighbors in the pipeline. The pipeline structures of the present invention are conducive to using steps that are nicely factored into clean steps with relatively simple input/output rules and minimal inter-step dependencies.

FIG. 6A is a block diagram illustrating one exemplary embodiment of processing step connections to show how steps may be connected in relation to each other. A particular step 222 is coupled to one or more input steps 224 (input step 1), 226 (input step 2), . . . , 228 (input step M) and coupled to one or more output steps 230 (output step 1), 232 (output step 2), . . . , 234 (output step N), where in general M≧0 and N≧0. A source step has M=0, N≧1. Such a step will generally supply data that is taken from something other than another processing step: say, from an input file, or from a hardware detector. A processing step has M≧1 and N≧1 and manipulates data in some way. Most steps are processing steps. A sink step has M≧1 and N=0. Such a step will generally send data to some destination other than another processing step: say, to a graphic display or to a separate software subsystem. By one approach, a pipeline terminates with sink steps that are coupled to other software subsystems. By another approach, a pipeline has no sink steps, and other software subsystems directly query the output of specific processing steps.

A single-input/single-output step has M=1 and N=1. Examples of this include filtering (such as smoothing or sharpening), gamma or other transforms (such as log or square root), cropping, resampling, or intensity scaling.

A multi-input/single-output step has M>1 and N=1. One example of this includes steps that combine multiple data streams (say, two data streams when M=1) with simple operations like addition, subtraction, multiplication, division, pixel-wise maximum, pixel-wise minimum, or quadrature summing or minkowski summation. Another example is a step that dynamically selects one input to pass through, and ignores the rest. More complicated multi-input steps are also reasonable, such as an algorithm that tries to detect common edges in two different input images. FIG. 6B is a block diagram illustrating another example, an algorithm that equalizes an image. The image viewer engine 28 is configured to analyze the dynamic range of an image at step 238, filter the image at step 240, and at step 242, uses the dynamic range information from step 238 in order to equalize the filtered image from step 240. Such an arrangement can be efficient if step 238 is slow but rarely updated, while steps 240 and 242 are updated frequently but are fast.

Note that any particular step may also output data to multiple other steps (for example, step 236 in FIG. 6B, or 122 in FIG. 5C). This can be handled in two different ways. In one case, the particular step 122 may send the same data to the downstream steps 126, 138. In general, step 122 is still considered to be a single-output step (i.e. N=1) since it produces a single unique output. Alternatively, the step 122 may produce different outputs for the data to send to step 126, 138, and hence step 122 is a multi-output step (i.e. N=2). In other words, the “number of outputs” characterizes how many unique data streams the step produces, though each unique data stream may itself route to multiple downstream steps. In FIG. 6B, since the same data is sent to 238, 240, then step 236 is considered a single-output step.

Each processing step can be considered as some kind of computation operation or mathematical operation, as illustrated in FIG. 6C. Suppose a pipeline structure has “x” as an input, and “y” as an output, with pipeline steps f, g, h and i. In this instance, the processing step x 244 represents a source step with no inputs and a single output that is routed to both steps f 246 and g 248; f 246, g 248, and h 250 are each single-input/single-output steps, and i 252 is a two-input/single-output step. Each of processing steps f 246, g 248, h 250, and i 252 are some mathematical operations, and the mathematical result of the pipeline is y=i{f(x),h(g(x)}.

Processing Parameters.

Each pipeline step has one or more processing parameters that affect the operation(s) that the step performs, for example a filter-strength parameter. In general, these parameters are either static (i.e. configured once and not changed) or dynamic (i.e. the user can modify them on the fly, say by GUI knobs, buttons, sliders, or dropdowns, or by physical knobs, buttons, or sliders, or by other controls such as a joystick, mouse, or other input device). A main advantage of this invention is how the pipeline deals with dynamic parameter changes.

For dynamic parameters, there are two different stages of the value for each processing parameter: employed and solicited. The employed value is the value that the step actually uses when the step performs calculations. The solicited value is a value that is set dynamically (by a user, a sensor, or another software system, etc.). Often, these two values are the same, but, for example, if a new solicited value is set while a processing step is in the middle of running, the step in general will wait to finish running before accepting the solicited value, so the employed values may lag the solicited values somewhat. More details are below under refresh strategies.

Refresh Strategies.

The pipeline architecture enables quick refreshes (e.g. at imaging frame rates in general approaching or even exceeding that of video) so that if, for example, a user modifies a parameter dynamically using the mouse, the screen repainting will keep up, even if this involves a good deal of computation under the hood. There are several possible refresh strategies, including:

Continuous: As soon as a refresh is completed, start a new one using the latest solicited values.

Periodic: Aim for periodic refreshes at some target rate (say, 30 frames per second), each time using the latest solicited values. Skip refreshes as needed if the refreshes take longer than the target rate.

Triggered: Refresh the pipeline only in response to specific events, such as when a parameter is modified, when a new background-processing task has returned a new result, or when some other sensor is activated. This can be done in several forms:

Queued: When a parameter is modified, add that change to a solicited-parameter FIFO (first-in, first-out) queue and if the pipeline is not already running, start a new refresh. At the beginning of a refresh, take the next available solicited parameter value from the FIFO and use it as the employed value for that same parameter. At the end of a refresh, if the queue isn't empty, start another refresh (and repeat as necessary).
Batched: When a parameter is modified, use the new value as the latest solicited value for that parameter. Only keep the most recent solicited value (rather than a queue) for each parameter. If the pipeline is already running, do nothing else. If the pipeline is not already running, launch a new refresh, using the most recent solicited values as the employed values. When the refresh is finished, if the pipeline is not up-to-date with the latest solicited values, begin a new refresh.
Batch Triggered with Late Injection: Like batched triggered, but if parameter modifications occur while the pipeline is running and the parameter modifications apply only to steps that are out-of-date and not currently running, apply the new solicited values immediately as the employed values for the affected steps.

These refresh strategies have different tradeoffs. In some software languages, Triggered Queued might be easiest to build; yet it is also likely to have the worst performance especially if the parameter changes can happen much faster than pipeline refreshes. Batched Triggered can be rather efficient, in general offers the most responsive experience, and at the same time leaves the most potential idle processor time (say, to be used for unrelated tasks). Batch Triggered with Late Injection offers the most responsive solution, but may not always be appropriate—the Late Injection approach tends to offer only very small performance benefits and at the same time may cause unwanted results if parameter changes to different processing steps are not fully independent. Continuous or Periodic are useful when some steps produce intermediate output before they are completed. Thus, Batched Triggered (without Late Injection) provides an attractive refresh strategy option. Periodic refreshes may also be added when using progressive or asynchronous steps.

FIG. 7 is a block diagram illustrating an example of a main software loop 254 that controls pipeline refreshes. At block 256, the pipeline engine 56 is configured to load data from one or more sources, such as the communication/network module 60, the data acquisition module 62, and a memory-storage module 64, as well as to initialize sources. At block 258, the pipeline engine 56 is configured to refresh the pipeline. At block 260, the pipeline engine 56 is configured to send data to the display module 66, and to update the display. At decision 262, the pipeline engine 56 is configured to determine if the output is up-to-date (or current). In some embodiments, the “is output up-to-date” decision typically takes the “yes” branch to block 264. When using the “yes” branch, the recursive loop 267 is essentially using the batch triggering method where the image viewer engine 28 is configured to wait for new trigger at block 264. At block 266, the pipeline engine 56 is configured to update employed parameters and step statuses before returning to block 258 to refresh the pipeline. The pipeline engine 56 is configured to determine that the “no” branch when there is a progressive step (as described below) that gives intermediate results on its way to its eventual stable result, which allows the computer system 10 to display intermediate results and still remain responsive even in the midst of a processing step that takes an extended time to fully complete. When using the “no” branch, the recursive loop 269 is essentially using Continuous or Periodic refresh, depending on the details of how the optional waiting period is implemented. As an optional step, the image viewer engine 28 is configured to wait for a period in block 268. This waiting is intended to provide extra computational resources so the pipeline's progressive step(s) can make more internal progress before sidetracking resources to perform another pipeline refresh by returning to block 258.

Active vs. Inactive Inputs.

Each processing step can optionally detect when one of its inputs is inactive (i.e., meaningless or unused). For example, in a step that toggles between two inputs, the step has one active input and one inactive input. In a step that linearly blends two inputs A and B, when the step is set to use 100% of input A, then input B may be inactive; when the step uses 100% of input B, then input A may be inactive; and when the step uses a non-trivial mix of A and B, then both inputs will be active.

In some embodiments, every input is considered to be in an active state (either because the implementer chose not to support the designation of inactive steps or because none of the steps in the pipeline merits an inactive designation (e.g., the pipeline does not have any steps that do toggling or mixing or similar)).

Step Disabling.

Sometimes it can be desirable to in effect “disable” a particular step (or to disable a facet corresponding to a particular step), meaning to turn off the effect of the particular step. There are two common ways to perform this. By one approach, disabling a particular step switches it into pass-through mode, where its output becomes a direct copy of its input. By another approach, when output from a particular step feeds into some other downstream step, disabling the particular step instructs the downstream step to ignore the output from the particular step. In the latter approach, for example, if a downstream step normally mixes input data from Step A and Step B, then disabling Step A causes the downstream step to use 0% of Step A and 100% of Step B, causing the input for Step A to become inactive.

Cache.

Caching is optional for each step. It is possible that all steps in a particular embodiments could be cached. However, very simple steps might actually be faster to recalculate than to cache. In a practical system, caching may be useful when involving outputs of more computationally intensive steps, while not caching on the output of computationally simple steps, except perhaps caching the end of a series of several computationally simple steps.

Several caching strategies may be deployed: fixed, configurable, or adaptive. In the fixed strategy, caching is part of each processing step's design, so the set of cached steps is fixed during pipeline implementation, such as at compile-time when using a compiled language. In the configurable strategy, caching is configured so each processing step has a flag indicating whether a cache should be created for that processing step. In the adaptive strategy, cache is allocated dynamically, such as by measuring how much memory is available for caching and to start enabling caching for different steps in order of processing requirement (i.e., starting with the slowest step first) and continuing to give cache to more steps until either a memory limit has been reached or all steps are cached. The adaptive (or dynamic) approach could also be configurable, so each step could be designated as never-cached, always-cached, or auto-cached (i.e., cache only if there is memory to spare).

Irrelevant Steps.

When discussing efficient pipeline refreshes, it is useful to introduce the concept of “irrelevant steps”. Relative to any particular pipeline output, an irrelevant step is one whose data does not affect that output. Consider, as an example, FIG. 5E. Relevant to step 186, step 188 is irrelevant, since the output of step 188 does not affect step 186. Similarly, relevant to step 188, steps 192, 204, and 186 are each irrelevant.

Optionally, inactive/active state might also affect relevancy. As an example, say that 186 is a toggle step that will pass through the output from either step 192 or 204, depending on the current toggle value of step 186. In this case, if 186 is set to pass through step 192 so 186's input coming from step 204 is flagged as inactive, then, relative to step 186, steps 188, 204, 202, 200, 198, 194, 206, 182, 214, 210, and 184 are all irrelevant. Conversely, if 186 is set to pass through step 204 so 186's input coming from step 192 is flagged as inactive, then, relative to 186, steps 188 and 192 are irrelevant.

Dirty vs. Clean Status.

Each step has a status flag that indicates dirty or clean status associated with a particular step. In some embodiments, the term “dirty” cache means that data associated with that step is out-of-date, and the term “clean” cache means that data associated with a particular step is up-to-date. Clean means that if this step were to calculate a new output, the output would be the same as the last time the result was returned.

If a step's output is requested, then
If the step is cached and clean, the step just returns its cached result.
If the step is dirty (whether cached or not), the step calculates a new output.
If the step is clean but not cached, the step calculates a new output. However, a downstream cached step can note that, if its inputs are clean, it need not query those uncached clean input steps for their results to begin with.

Push vs. Pull Flows.

The propagation of both data (e.g., signal or image data) and status flags can each be performed in either a push-style method or a pull-style method. In a push-style method, each step sends its output to input of the step(s) immediately downstream, and this process recursively repeats. In a pull-style method, each step requests the outputs from the step(s) immediately upstream, and those steps may recursively request outputs from their input steps, and so on. Each flow (data flow or different types of status flow) can be push-style or pull-style without departing from the spirit of this invention. Additionally, the same style (e.g., pull-style) can be used to manage all flows, in which case a single flow can handle both status and data updates. In one embodiment, the pipeline engine 56 is configured to use pull-style data propagation with push-style status propagation.

In one embodiment of a processing pipeline, a design goal is to only perform calculations necessary for the currently requested output, ignoring separate calculation branches and steps for which we can use an up-to-date cached result. For example, in FIG. 5E, suppose we want an updated result from 186, and that boxes 180, 190, 192, 182, 206, 194, 184, 210, and 214 are unchanged since we last ran the pipeline. In this case, we want to recalculate steps 198, 200, 202, 204, and 186, and avoid calculating 188 (which doesn't affect 186) as well as avoiding recalculating any of the unchanged steps. In the pull strategy, we request data from 186, which requests data from 192 and 204. 192 returns its cached result. 204 requests data from 202, which requests data from 200 and 210. 210 returns its cached result, while 200 requests data from 198 and 214. 214 returns its cached result, and 198 requests data from 194, which returns its cached result. In the push strategy, status logic identifies step 188 as irrelevant and identifies steps 192, 194, 210, and 214 as push sources, which push their cached data downstream through out-of-date steps (avoiding irrelevant steps). In general, for push-style, we must either compromise our goal (sometimes performing unnecessary computations) or we require both complicated status updates (to detect push sources and irrelevant steps) and complicated data flow (to cleanly handle pushing to multiple-input steps). In contrast, pull-style data flow is much cleaner to avoid unnecessary computations.

In another embodiment of a processing pipeline, a similar but subtly different goal is to minimize lag: that is, to minimize the total amount of time between when any parameter or data has changed and when an updated output is delivered to the user. With this goal, it may sometimes be desirable to push data through irrelevant steps so if another output involving currently irrelevant steps is later requested, those irrelevant steps can be pre-computed. Additionally push can be desirable if there is a time delay in between when a step becomes out-of-date and when an output request occurs. Yet pushing to irrelevant steps immediately (while we are waiting for an output) can cause lag. Thus, in situations where lag is paramount, a hybrid push/pull data flow can be desirable. That is, if the processor is idle, it works on pushing data down the pipeline, but when an output request occurs, the push is interrupted and the pull commences. When the pull finishes, the push can resume (though pushing to out-of-date steps only, noting that some steps may have become up-to-date since the push was suspended).

Similarly, status updates may be performed from a push or pull perspective, depending on the particular embodiment. The goal of a status update is to help identify which steps are necessary to recalculate in the data flow. Consider FIG. 5E and say that we want updated output from step 186, and that, since we last refreshed the entire pipeline, the only step with an employed parameter change is step 198. Then, to get an updated output to step 186, we should rerun steps 200, 202, and 204, and re-use cached results from the rest of the pipeline. In pull-style status update, to see if each step is up-to-date, each step queries whether the steps upstream from it are up-to-date. In other words, 186 asks 192 and 204; 192 asks 190; 190 asks 180; 204 asks 202 and 194; 202 asks 200; 200 asks 198 and 214; 198 asks 194; 194 asks 206 and 190; 206 asks 182; 214 asks 210; and 210 asks 182 and 184. This pull-style status flow has the advantage that, when doing pull data flow, we can combine both data and status into a single joint flow. However, pull status flow has several disadvantages. First, as we will see, we perform more queries than push-style does, as may end up querying every step in the pipeline. Second, multiple steps may query the same step—in the given example, 204 and 198 each query 194; 192 and 194 each query 190; and 210 and 206 each query 182. Additionally, depending on the embodiment, 194 and 190 may themselves query their upstream steps multiple times (though this may be avoided by extra status logic to note whether a step has already been queried). Third, in the example where 198 has a parameter change, after updating step 186, we must also note that step 188 is also out-of-date, say by pulling status for 188 as well. While all of this is technically possible, for typical embodiments, a push-style status update is much cleaner. In push-style status flow, in the example where step 198 has a parameter change, we mark 198 as out-of-date, which marks 200 out-of-date, which marks 202 out-of-date, which marks 188 and 204 out-of-date, and 204 marks 186 out-of-date. In conjunction with pull data flow, a data pull request on 186 updates steps 198, 200, 202, 204, and 186 to produce an updated output. The irrelevant step 188 is not recalculated, but is marked out-of-date so future pull requests on 188 will work correctly.

In some cases, it may be convenient to use the same style (say, pull-style) to manage all flows, in which case a single flow can handle both status and data updates. However, for the reasons listed above, when the ultimate goal is minimizing computations, we find it most efficient to use pull-style data propagation with push-style status propagation. When the ultimate goal is minimizing lag, we find it most efficient to use hybrid foreground-pull/background-push data propagation, with push-style status propagation.

### Refresh Mechanics for Simple Flow

The illustration begins with a simple embodiment using only simple steps. A simple step produces a stable output each time it is called. We will discuss alternatives to simple steps in other embodiments below. In general, this simple flow is appropriate when all steps run to completion in a fairly short amount of time.

Parameter Changes.

When a new parameter is employed, the affected step(s) are immediately marked dirty.

Status Flow.

For status flow, a push-style and a pull-style are two possible methods, although the push-style tends to be a cleaner approach. In the push-style, when a step is marked as dirty, all of the downstream steps relative to that step are also marked as dirty. This can be accomplished recursively, such that each step marks its immediate output steps as dirty, then the process repeats.

This propagation may be immediate or delayed. In immediate propagation, when a parameter changes, the affected step is marked as dirty and immediately all downstream steps are marked as dirty. In delayed propagation, when a parameter changes, the affected step is immediately marked as dirty, but do not push the dirty flag downstream (yet). Then, at the beginning of the next refresh, any dirty steps are identified and pushed downstream. Delayed propagation has an advantage in avoiding multiple redundant flag propagations if a parameter has changed multiple times between refreshes (which is especially convenient with batch triggering). But delayed push also has another potential advantage in that the delayed push can deal with inactive inputs better—when propagating a dirty status, it is not necessary to propagate the dirty flag through inactive inputs. However, with immediate push, if it is possible that the active/inactive state of an input will yet change before the next refresh, it cannot necessarily abort status propagation when encountering an inactive input. With delayed propagation, the inactive/active statuses can be updated first then the dirty flag can be safely propagated.

Data Flow.

For data flow, a basic goal is to perform calculations, which (a) affect the current output, and (b) have changed since the last time they were run. While it may be technically possible to do this with a push-style pipeline, in general pull-style data flow makes it more straightforward to achieve this goal. In pull data flow, output is requested from one or more output steps (i.e. sink steps) in the pipeline. Each step then performs the following, recursively, beginning with the output steps corresponding to the requested outputs:

If this step is a source step (i.e. a pipeline input step), return its source data (and mark the step clean).

If this step has a clean cached result, return that cached result.

Otherwise:
For each step that is an active input to this step, query that step for its output.
Then calculate a new output for this step, using the newly received input data.
If cache is enabled for this step, cache the new result.
Then return the result and mark this step as clean.

FIG. 8 is a flow diagram illustrating how a simple pipeline is refreshed for a simple flow as affected by the main software loop in FIG. 7. A push-style refresh logic and pull-style data flow is employed in diagram. At step 270, the image viewer engine 28 is configured to propagate status flags. At step 272, the image viewer engine 28 is configured to find the appropriate sink step for each desired output, as well as configured to request output from the output steps.

FIG. 9 is a flow diagram 276 illustrating the propagation of status flags for simple pipelines (by using delayed update) from 270 in FIG. 8. Note that the sequence on the right calls itself recursively. At step 278, the image viewer engine 28 is configured to identify changed steps. At step 280, the image viewer engine 28 is configured to send dirty status to each changed step. At step 284, a step receives a dirty status. At step 286, the image viewer engine 28 is configured to mark the step that receives a dirty status as dirty. At step 288, the image viewer engine 28 is configured to send dirty status to each of this step's output steps, which then return to 284 for recursive processing.

FIG. 10 is a flow diagram illustrating the process of requesting output from a step for simple pipelines.

FIGS. 11A-E are block diagrams illustrating an example operational flow of a simple pipeline.

Suppose the pipeline begins with all steps marked clean, and that all steps are cached, and that the pipeline is holding in block 264 in FIG. 7. Now suppose the user solicits some new parameter value, which is then employed (a la 266 in FIG. 7) to the appropriate step in FIG. 11A. We then refresh the pipeline (i.e. 258 in FIG. 7), which corresponds to diagrams FIGS. 11A-C. In diagram FIG. 11B, a dirty status propagates down the pipeline (corresponding to FIG. 9). In FIG. 11C, an output request is made (from the third block in FIG. 8). In FIG. 11D, outputs are then propagated and calculated according to FIG. 10 and the output is returned. At this point, we have just completed the pipeline refresh (258 which is also FIG. 8), and the pipeline engine in FIG. 7 moves on to 260, updating the display. The pipeline engine in FIG. 7 then determines if the output is up-to-date 262, and takes the “yes” branch, return to 264 (which is the image viewer engine's “Wait for new trigger” state), with the pipeline resting in the state shown in diagram FIG. 11E.

Note that the pipeline is now resting with a dirty step. This can be avoided by using push-style logic, or by using the above logic but requesting output from all sink steps at once. However, this example also demonstrates that if not all outputs are desired to have the same refresh rate, they may be requested at different rates. In this example, the first output might be an image that must be shown very responsively, whereas the second output might be the result of an automatic-detection algorithm that can be refreshed more slowly.

Initialization.

When first instantiating a pipeline, all pipeline steps begin dirty. When loading a new data set, by one approach, one can also set all pipeline steps to dirty. By another approach, one can treat this similarly to a parameter change. In other words, when changing the data in a source step, that source may leave itself marked “clean” but push a dirty flag to its downstream steps. When a pipeline only has one source step, or all source steps change at the same time, these two approaches are equivalent. But when a pipeline has multiple source steps (say, multiple data sets for multi-modal imaging), this second approach avoids recomputing results from one unchanged source step when changing the data to another source step. This can be especially useful if the two data sets are not close to each other in the pipeline or if the two data sets naturally refresh at different rates.

### Extensions for Slow Steps

Two approaches are introduced for dealing with slow steps. First, asynchronous steps run in the background and produce new results asynchronously to pipeline refreshes. Second, progressive steps are steps that are capable of producing intermediate output en route to arriving at a stable computed answer. Progressive steps can produce new output synchronously, i.e. only during a pipeline refresh, or asynchronously, i.e. during a background job.

Synchronicity.

A synchronous step is a step that only produces a new output each time the step is explicitly run (such as in response to a data pull request or a data push). An asynchronous step is a step that can produce new output asynchronously from pipeline refreshes, typically by running some background job. (Note that an asynchronous step may optionally also produce synchronous output.)

Transitory/Stable Status.

Any step can be marked as either transitory or stable, which describes the state of the step's output. This status is orthogonal to clean/dirty status. Transitory status signals an intermediate result; i.e. there should be a new result coming soon. Stable status signals that the step and all steps that came before it have arrived at their final answer (that is, final until a new parameter change occurs).

When combined with clean/dirty status,

Stable Clean status signifies that data is up-to-date and will not change until a new parameter change arrives.

Stable Dirty status signifies that data is out-of-date (and ready to be recalculated), with the assurance that, once it is recalculated, it will not change again until a new parameter change arrives.

Transitory Clean status signifies that the last output is still the best we can currently do (i.e. there is no point in recalculating it at this time), but a new update will be coming soon.

Transitory Dirty status means it is possible to obtain an improved result since the previous output, but doing so would only give an intermediate output. In some cases it is useful to update transitory dirty data in order to improve the apparent responsiveness of the system, at the expense of taking longer to arrive at stable data. In other cases, it is more important to get to stable data sooner, and one might avoid updating transitory dirty data.

Accordingly, each step can be configured to be:

Greedy: A greedy step is willing to process transitory data.

Thrifty: A thrifty step will not process transitory data, but instead wait for stable data.

In general, very slow steps should be set to thrifty, whereas faster steps might be set to either greedy or thrifty, depending on the importance of immediate responsiveness vs. the time to stable output.

Synchronous Progressive Steps.

One approach to progressive steps that requires minimal modification of the aforementioned pipeline framework is to use synchronous progressive steps.

In general:

When a synchronous progressive step first embarks on a new calculation (that may span multiple refreshes), it propagates a transitory status down the pipeline, in addition to the usual dirty status.

When a synchronous progressive step produces an output.
If the calculation is complete, it marks itself clean and sends a “stable” status down the pipeline.
If the calculation is still in progress, it leaves itself dirty after producing the output.

A simple step is equivalent to a synchronous progressive step whose calculation always completes each time it runs.

Progressive steps may also continue processing in the background, even for a strictly-synchronous step. As long as they are indicating transitory status, a strictly-synchronous step should always return a new (hopefully improved) result every time it is called.

To support progressive steps elsewhere in the pipeline, all steps (including simple steps) should, when they have calculated a new output, only mark themselves clean if all of their inputs have been marked clean.

When propagating a “stable” status, a step with multiple inputs should only continue to propagate the stable flag downstream if all of its inputs are stable.

Progressive Steps are explained and elaborated by a concrete example in the following section before moving to Asynchronous steps.

Refresh Mechanics with Synchronous Progressive Steps

This section specifically describes status flow for a pipeline with synchronous progressive steps, in contrast with the previously described simple pipeline example.

Status Flow.

For a pipeline with synchronous progressive steps, the propagation of status is illustrated in FIG. 12 (contrasted with FIG. 9 for a simple pipeline). FIG. 12 is a flow diagram illustrating the propagation status flags for a pipelines with synchronous progressive steps. The flow in FIG. 12 involves three recursive procedures. The first is propagating “transitory” status, which is initiated by progressive steps. The second is propagating “dirty” status, which is initiated by any step (simple or progressive). This is essentially the same as in FIG. 9, except that a dirty status does not propagate on a transitory path through a thrifty step. The third procedure is to propagate “stable” status—this is listed on FIG. 12 since it is a status flow not a data flow, but it is triggered during data flow (see FIG. 13).

Data Flow.

FIG. 13 is a flow diagram illustrating the data flow resulting from a request for output from a step with progressive step support. The data flow in FIG. 13 is similar to FIG. 10 with two changes. First, if a progressive step is not finished, it does not mark itself clean or cache its result. Note that a simple step always takes the “Is this step finished calculating”=“yes” branch of 466. Secondly, every step checks to make sure all of its inputs are clean before marking itself clean and caching its result. This is intended for steps that are downstream from a progressive step. The step itself might not be progressive, but it may still be receiving updates from a progressive step. Note that each step updates its own output status before returning control back to the downstream step that requested this step's output.

FIGS. 14A-E 480, 484, 512, 528, 570 are block diagrams illustrating an example pipeline operational flow with synchronous progressive steps. All steps in this example are greedy. In this example, the parameter change is upstream from the progressive step. In 484, the changed step and all steps downstream from it are all marked dirty. Additionally, the synchronous progressive step 488 and all steps downstream from it are all marked transitory (though in this example, since all steps are greedy, the transitory flag never affects anything). In 512, an output request is made. In 528, each dirty step produces a new output. However, since the progressive step 540 is not finished, it remains dirty at the end of this process at 572. Additionally, since the progressive step 572 remains dirty, all the steps downstream from it (574, 576, 578, 580) also remain dirty (since not all of their inputs have become clean, a la block 470 in FIG. 13). Thus, at 570, the progressive step and all steps downstream from it are dirty. The main software loop (FIG. 7) can then notice that the output is still dirty, and thus automatically launch a new refresh (without waiting for a new trigger).

FIGS. 14F-M 582, 586, 600, 642, 654, 692, 696, 704 are block diagrams illustrating an example pipeline operational flow with abridgments.

### Asynchronous Steps

Asynchronous Steps.

So far, the discussion has been on synchronous steps, i.e. steps that only produce an output when one is requested. However, it can also be desirable for steps to produce results asynchronously. A common use case is when one or more steps take significantly longer to run than would be required to meet a desired refresh rate. Say, for example, that most steps take a few milliseconds, but one step is slow and takes hundreds of milliseconds, or even seconds or longer to complete. In this case, it can be desirable for the slow step to quickly return an inferior or out-of-date result so that responsiveness can still be maintained for any steps downstream from the slow step, while at the same time churning away at in the background to produce an improved result.

Unlike synchronous steps, asynchronous steps have some flexibility in when they become dirty and/or cause their downstream steps to become dirty. In general, some asynchronous steps are capable of quickly producing a low-quality preliminary result, and will produce one or more improved results later. Such steps should typically be configured to become dirty in immediate response to a change in their processing parameters or input data. In contrast, some other steps may take some time before producing their first result. Such steps should typically be configured to remain clean after a change to their processing parameters or input data, since their output is not ready to change yet. Regardless of how it immediately reacts to parameter or data changes, when an asynchronous step receives a new asynchronous result, it should mark any relevant downstream steps as dirty.

Refresh Logic.

FIG. 15 is a flow diagram illustrating the process to refresh a pipeline with asynchronous support. There is an extra block in which, in between updating status and performing an output request, a new background job may be initiated, i.e. a calculation task running in the background. To start a new background job (718), first request output data (similar to FIG. 13) from the input steps to the asynchronous step (720, 722). Then a background processing is launched (724), using the requested data as the input data for the calculations. Once the background job has been launched, the image viewer engine 28 is configured to move on to request and wait for output data. However, if the pipeline has an asynchronous step that has not yet produced a new output, there may not be any new output available. Thus, rather than requesting data from every output, the image viewer engine 28 is configured to check first to see if any outputs are dirty, then update only those outputs.

Status Flow.

For a pipeline with synchronous progressive and asynchronous steps, the propagation of status is illustrated in FIG. 16. This figure shows an updated status flow 726 to support asynchronous steps. FIG. 16 is similar to FIG. 12, except that asynchronous steps also propagate transitory messages, and the status flow may also identify new background jobs that are ready to start. The “new background job” block 764 in FIG. 16 can be run immediately or delayed. When running it immediately, the “launch a background job” blocks 718, 720, 722, 724 from FIG. 15 are run immediately when we encounter the “new background job” block 764 in FIG. 16. When running it delayed, when we encounter the “new background job” block 764 in FIG. 16, we just flag or log the appropriate step. Then the new background job is actually launched after the status flow completes. Note that FIG. 15 is written for the delayed case.

Data Flow.

A new figure is not provided for asynchronous data flow because the data flow for a pipeline with asynchronous support is the same as the data flow already illustrated for a pipeline with progressive steps in FIG. 13.

Asynchronous Results.

FIG. 17 is a flow diagram illustrating the process of handling an asynchronous result notification. This figure shows what happens when a background job generates a new result. In general, this result occurs at a time asynchronous to the pipeline refreshes. When the background job (corresponding to some asynchronous step) generates a new result, we treat that very similarly to the way we would if we had just requested new output from a synchronous progressive step. If the job has finished, we propagate a stable status, otherwise the step remains transitory. Regardless of whether transitory or stable, we also propagate a dirty status downstream, since downstream steps now have a new input to work with.

Additionally, the dirty status in general means that either an output has become dirty and is ready to be recalculated or a new background process is ready to start (or both). Thus, when a new result is available, we notify the main software loop. Essentially, an asynchronous result is treated as another type of trigger (similar but different to a parameter change), as in the “wait for new trigger” block 264 in FIG. 7.

Asynchronous Example.

FIGS. 18A-P are block diagrams illustrating an example pipeline operational flow with thrifty asynchronous steps. In FIG. 18A, a parameter change effects one of the steps. In FIG. 18B, this turns some steps dirty, but in this example the two asynchronous steps remain clean (since they are not ready to return new data yet). Additionally, two different asynchronous steps issue “transitory” statuses (though the second is redundant to the first), and a new background process is identified. In FIG. 18C, we launch the new background process, beginning by requesting the required input data. FIG. 18D shows the new state. Since the asynchronous step is running but has not yet produced a new output, and the second asynchronous step is thrifty and hence does not propagate the dirty status, the output remains clean so there is no point in the pipeline issuing an output request. In FIG. 18E, an asynchronous background result appears, and we propagate status accordingly, which in this case now marks the pipeline's output dirty. To show an updated intermediate output, we thus issue a new output request in FIG. 18F, which uses the new intermediate result from the first asynchronous step, with the old cached result from the second asynchronous step. FIG. 18G shows the new status. In FIG. 18H, we receive another asynchronous update, this time that the first asynchronous step has finished. A status propagation follows, including a new “stable” status update which propagates downstream until it hits another asynchronous step. This status propagation also identifies that the second asynchronous step is ready to start. In FIG. 18I we thus launch a new background process, which in turn calculates the required new input data. FIG. 18J shows the new status. At this point, the pipeline could issue a new output request for the dirty output, but in this example the main software loop decides not to perform the request (say, not enough time has elapsed between the last refresh and the asynchronous step producing a new result). In FIG. 18K, the background job produces a new result, and status propagates. In FIG. 18L, we calculate a new intermediate result—presumably better than that from diagram 6, but still not entirely up-to-date. FIG. 18M shows the new status. In FIG. 18N, the second asynchronous step asynchronously finishes and returns its result, which triggers a new status update, including issuing a new “stable” status, then triggers the main software loop. In FIG. 18O, we request a new output result, and perform the required calculations. FIG. 18P then shows the resulting pipeline state.

### Other Features

Coupled Parameters.

One potential issue is parameter coupling between two processing steps. In the simple case, this happens when two steps need the same parameter value. This can be thought of as an “equality” coupling, i.e. where the employed parameters for two different steps must be equal. More general couplings can also exist, such as when an employed parameter for one step must be a certain nonlinear function of another employed parameter for another step.

Two examples of parameter coupling:

### Example A:

Early on, a processing step applies a gamma function, y=x^{γ} for every pixel (say, for example, γ=0.5 (which is equivalent to taking the square root) in order to compress the signal). Several more processing steps then work on this gamma-adjusted signal. Then, at the end of the pipeline, another step undoes the gamma function by applying y=x^{1/γ}. The two steps must use the same γ value.

### Example B:

Pan & zoom is applied early in the pipeline in order to crop and/or resample data to reduce the data size to only what will be displayed (for faster processing for the rest of the pipeline steps). However, since some later processing steps may need a neighborhood around each pixel, instead of cropping directly to the displayed region we leave an apron of extra off-screen pixels and crop to that enlarged region. A second stage near the end of the pipeline then crops away the apron. The two stages must also agree on the apron size.

In pipelines with simple flows, coupled parameters are straightforward since we can set the employed parameters for both steps simultaneously. However, with asynchronous steps, parameters can be mismatched. For example, consider FIG. 18. Say that the step that is changed in FIG. 18A has a parameter that is coupled to another parameter in the output step that we call in diagram FIGS. 18F, 18L, and 18O. In FIG. 18F, data flowing from the first asynchronous step is based on values from the new parameter value, while data flowing from the second asynchronous step is still based on the old parameter value. Hence it is not clear whether the final output step in FIG. 18F should use the old or new parameter value, and either way the result may be undesirable.

There are several further extensions of this invention that solve this problem:

A first approach is simply to statically configure all steps with coupled parameters to be thrifty. In the above example, the two steps with coupled parameters would always be set to thrifty. However, this approach prevents the later step from reacting to any transitory data, even data where the two coupled parameter values are still employed (say, the transitory flag came from some other signal path unrelated to the coupled parameters).

A second approach is to dynamically make a step thrifty temporarily. In the above example, we could ordinarily have the two steps of interest be greedy, but if we modify a parameter in the first step, we switch the second step to thrifty until it becomes stable, then switch it back to greedy. This approach is often sufficient, but can still be confused by a transitory status coming from alternate signal paths.

A third approach is therefore to propagate parameter-specific information. In this case, we first define a set of “fragile” parameters for which we take extra care not to mix data using different parameter values. When propagating statuses, in addition to the usual status flags we also propagate a list containing all the values that have been employed for any fragile parameter. If a status update pushes a fragile parameter value set that conflicts with the step's existing fragile parameter step, that step cannot be calculated until either the fragile parameter set values agree again, or the step becomes stable (which is in general easier to check). This approach requires more special handling than the first two approaches, but that handling, while difficult to develop, will in general be trivial in terms of computational effort. Furthermore, this approach offers the most flexibility in terms of giving a responsive interface while at the same time avoiding artifacts due to mismatched parameters. An extension of this approach is also to allow steps to have special responses to data with mismatched coupled parameters. For example, consider a step C that is configured to mix the results from step A and step B. Step C could be further configured so that if A and B have matched coupled parameters, C mixes A and B, but if A and B have mismatched coupled parameters, then C returns only the result from A. In the future, when A and B become matched, C then returns a mix of A and B.

In practice, any of these three approaches might be useful, depending on the application. Additionally, many applications do not suffer from fragile parameter problems to begin with, in which case none of these three approaches is necessary.

Pipeline Loops.

In some cases (such as with iterative algorithms), pipeline loops might be desirable, as in FIG. 5B. This can be handled with small modifications to the invention. For example, during a data pull request for 108, step 114 may use the cached result from 116, so, in effect, path 118 has a one-refresh lag. Furthermore, a background process could continually refresh step 116 in the background (performing 114 and any other steps that are necessary), with 108 performing more rare updates that simply query the latest output result from 116. There are many possibilities in this regard, and the best choice may depend on the application, algorithm, computing hardware, desired responsiveness, or other factors.

Status flow would have to be similarly modified. For example, when pushing a status update, the status flow would terminate when encountering a step that has already updated. For example, if a user changes a parameter in step 110, that would apply dirty status to 110, which would apply dirty status to 112, which would apply dirty status to 114, which would apply dirty status to 116, which would apply dirty status to 114 and 108. When 116 applies dirty status to 114, the pipeline would note that 114 has already been marked dirty in this update, and the status flow would terminate at 118 (though the dirty status would continue to propagate down 108 and beyond, if there were more steps). Alternatively, if 116 received a parameter change, that would apply dirty status to 116, which would then apply dirty status to 108 and to 114, and 114 would attempt to apply dirty status to 116 before terminating.

Efficient Homography.

Image viewers commonly support pan and zoom (i.e. translation and scaling) operations. In some cases, other operations such as rotation, skew, or perspective transformation may also be important. These are all special cases of planar homography, i.e. mapping data from one plane onto another. Even more generally, we can consider non-planar homography, i.e. mapping between more general surfaces. One important example is mapping data from an arc-shaped or L-shaped detector array onto a planar viewing surface. Note that we also consider cropping a data set (as well as its opposite—extrapolating a data set) to be a homographic operation, as it transforms data from a plane of one size to a coincident plane of a different size.

By one approach, homography fits straightforwardly into our pipeline framework by adding a single homographic transformation step near the end of the pipeline. This approach has the advantage of allowing very fast manipulation of the homographic transformation, but with the downside that all upstream processing steps may be operating on a larger data set (i.e. larger spatial extent and/or finer sampling) than necessary.

By another approach, a homographic step can be placed near the front of the pipeline. This has the advantage that most of the pipeline works on a reduced data set, so most steps can be updated very quickly, but with the disadvantage that changing the homographic transformation (say, by panning or zooming the image) can result in many computations and thus be unresponsive.

By a third approach, a homographic transformation can be placed in the middle of the pipeline, placed downstream from steps that are particularly slow and/or change rarely, but upstream from steps that change frequently and/or are fairly quick to recalculate. In many cases, one of these approaches is sufficient.

Another approach to homography is to split into multiple stages, say a first stage that crops and only downsamples (if necessary), and a second stage that upsamples (if necessary). Alternatively, a first stage may do mild downsampling (if necessary) and later stages may do additional resampling.

Another approach to homography involves explicit abridgment support, as described below.

Abridgments.

Another extension to the pipeline framework involves explicit data abridgments, which are some reduced (i.e. abridged) versions of the full data set. An important example is to designate a full-size full-resolution image as the unabridged image, and a zoomed (i.e. after scale, pan, and crop) image as the abridged image. To update a computer display, it is unnecessary to generate pixel values for pixels that are outside the display region, and similarly it is unnecessary to generate an image at resolution much finer than the display resolution. Hence, to update a computer display, it is sufficient to request abridged data from the pipeline. However, other algorithms such as global analysis algorithms (which inspect off-screen pixels as well) still need access to unabridged data. By caching unabridged data when possible, abridged data can in many cases be quickly derived from the cached unabridged data, thus avoiding calculations. When up-to-date cached unabridged data is not available, steps can compute new abridged data, which is typically much faster than calculating new unabridged data, but often slower than deriving abridged data from the unabridged data. When idle, the pipeline can go back and calculate and cache new unabridged data.

When directly calculating abridged data (because no unabridged data is available), a step can either calculate a result that is equivalent to what it would get from deriving an abridged result from unabridged data or it can calculate a result that is different (typically degraded) from what it would get from deriving an abridged result from unabridged data. The former is called an exact-abridging step. The latter is called a progressive-abridging step. Essentially, a progressive-abridging step is a special type of step that acts as a progressive step when it gets an abridged data request, though it may not necessarily be progressive on unabridged data.

A particular approach for incorporating abridgments into the pipeline is described below. In this approach, steps have separate clean or dirty flags for each of their unabridged and abridged output. Steps' caches can also cache unabridged or abridged output, though for any particular step the cache need not necessarily store both unabridged and abridged data at the same time.

If unabridged output is requested from a particular step (using pull-style data flow) and the particular step has a clean cached unabridged output, the step returns the cached output. If unabridged output is requested from the particular step and it does not have a clean cached unabridged output (either because the unabridged output is dirty or because the step is not cached), then the particular step requests the output data from each of its input steps, then calculates a new unabridged result, caches that unabridged result (if cache is enabled), and marks its unabridged output clean (unless a new progressive unabridged calculation is ready to start). So far, these steps are consistent with previous descriptions of the pipeline, wherein, essentially, all data can be considered unabridged.

Now suppose an abridged output is requested from the particular step. If the step has a clean cached abridged result, it returns that cached abridged data. If the step does not have a clean cached abridged result but does have a clean cached unabridged result, it derives the abridged result from the unabridged result (for example by downsampling and/or cropping it) and marks the abridged result as clean. If the step does not have a clean cached result of either type (either because the result is dirty or because cache is not enabled), the step calculates a new output as follows. If the step can tolerate abridged input data, it requests abridged data from each of its input steps and calculates a new abridged result and caches that abridged result (if cache is enabled), and marks its abridged result clean (unless a new progressive abridged calculation is ready to start). If the step cannot tolerate abridged data, it requests unabridged data from each of its input steps, calculates a new unabridged result, caches that unabridged result (if cache is enabled), derives an abridged result from the unabridged result, marks both its unabridged and abridged results clean (unless a new progressive unabridged calculation is ready to start), and returns the unabridged result.

This approach has the advantage that after something pulls an unabridged result, that result remains available for quickly deriving abridged data, but if unabridged data is unavailable and abridged data is requested, then the calculations only need process the unabridged data sets. Additionally, steps may choose to give a degraded result when calculating (rather than deriving) an abridged result. Steps that choose to do this are called progressively-abridging steps and, relative to their unabridged calculations, during their abridged calculations these steps may use techniques such as reduced numerical precision, reduced bit-depth, decreased filter sizes, more approximate algorithms, or only processing low order transform coefficients (such as wavelet or Fourier coefficients).

In addition, it can be useful to use idle time to generate unabridged data in the background. While this can technically be done with both push and pull approaches, this approach is especially suitable with the hybrid background data-push/foreground data-pull data flow. In this approach, a foreground data-pull performs the pull requests described above, which can be for either abridged or unabridged data. When idle, a background data-push finds steps with dirty unabridged results (regardless of their abridged status) and pushes unabridged data through them. If interrupted by a foreground data-pull, the background data-push halts or pauses, and the foreground data-pull obtains new data (which may be either abridged or unabridged). When the pull request completes, the background process goes back to pushing unabridged data through the pipeline. As each step completes its data push, both its abridged and unabridged statuses are marked clean (unless the result is an intermediate progressive result), and the unabridged result is cached (if cache is enabled). When a background push terminates (either because it was interrupted or because it has reached the pipeline output), of the steps it updated, it finds the steps that are furthest downstream and marks all those as having fresh output. The “fresh” flag indicates that the output is not just clean but also has yet to fully propagate. When a step is marked dirty or when its output is pushed down the pipeline or when its output is requested via a pull request, the step's fresh status is revoked.

The approach of giving abridged and unabridged data separate (but related) treatment is useful in that, once unabridged data is calculated, abridged data can be returned nearly instantly, making some homographic manipulations (such as panning or in some cases zooming) extremely fast. Conversely, if other parameters are changing, or we have not yet had a chance to refresh the pipeline with unabridged data, then the system need only process the abridged data, so responsiveness can still be very fast in that case, though perhaps with temporarily degraded results.

Example Pipeline with Abridged Steps.

As an example, in FIG. 14F 582, a parameter is changed in 584 that invalidates both the abridged and unabridged data, and in FIG. 14G 586, all steps from 588 onwards are marked dirty for both data types. Next in FIG. 14H 600, abridged data is pulled from the pipeline output. Step 614 requests abridged data from 612, which requests abridged data from 616 and 610; 610 requests abridged data from 608 and 618; and 608 requests abridged data from 602. Since 606 cannot handle abridged inputs, it requests unabridged data from 604, which in turn requests unabridged data from 602. 602 returns its unabridged cache, while 616 and 618 return abridged data derived from their unabridged caches. FIG. 14I 642 then shows the new statuses. 604's output is marked fully clean, while steps 644, 646, 648, 650, and 652 all have their abridged output marked clean but unabridged status left dirty. FIG. 14J 654 then shows the background push process, which begins with 660 (which is the first step with dirty unabridged data) and pushes unabridged data downstream through all steps with dirty unabridged data, using cached unabridged data from other steps as necessary. FIG. 14K 692 shows the status after this operation. All steps in the data-push have their outputs marked fully clean, and since the push process ended with step 694, that step is marked fresh (note that in a multi-output pipeline, more than one output could be marked fresh). In FIG. 14L 696, the main software loop also receives a notification of this fresh status, and executes another pull request, again for abridged data. This time, the pull request merely derives abridged data from the unabridged cache in step 698. In FIG. 14M 704, the pipeline is back to an all clean state. Note that while the pipeline has all clean unabridged data, for any changes that affect only how abridged data is derived from unabridged data (such as pan, crop, downsample operations), such operations can be extremely fast as they only require deriving new abridged data from step 698, without actually recalculating any steps. The abridgment idea can also be naturally extended to multiple levels of abridgment (say cropped, cropped and mildly downsampled, and cropped and severely downsampled), as well as non-homographic abridgment such as only reconstructing certain preview slices of a 3D volume, or other special preview renderings.

Parameters vs. Source Steps.

Note that the differentiation of step parameters vs. source steps is somewhat artificial. Any parameter can alternatively be expressed as a source step. Similarly, any input data (even a data set of multiple gigabytes) can be considered to be a parameter to a processing step. In practice, the difference is usually one of convenience. When considering simple values such as a toggle, enumeration, or single floating point number, step parameters can be less cumbersome and hence preferable to source steps. When considering large complex data sets, source steps can be preferable as they allow implementation details such as a file reader or framegrab interface to be well separated from the processing steps. For other types of data such as configuration structures or binary calibration data, either approach (source steps or step parameters) can be reasonable.

### II. Specific Pipelines

Up to this point, the discussion has been on a new type of processing pipeline at a general level. Now, the attention is turned to several specific embodiments of such a processing pipeline.

### Radiography Pipeline

FIG. 19 is a flow diagram illustrating a pipeline optimized for inspection of radiographic images. Roughly speaking, a radiographic image depicts how attenuative (or equivalently, transmissive) is the X-ray path corresponding to each pixel, so each pixel roughly indicates local material density and amount. On one particular set of commodity graphics hardware, refreshing the entire illustrated pipeline when all steps are dirty takes approximately 100 milliseconds. Thus, when recalculating all steps every time, the pipeline can be refreshed at a rate of roughly 10-15 frames per second. Using our new pipeline framework, with cache enabled for all steps and only performing calculations for out-of-date steps, most pipeline refreshes can occur at rates in excess of 50 frames per second (even well in excess of 50 frames per second, when parameter modifications only affect steps near the pipeline output) on the same particular set of commodity graphics hardware. Note that these numbers are dependent on data size (refresh may be faster for smaller images and slower for larger images), image processing algorithms (refresh may be faster when switching to alternative algorithms that require fewer computations, or slower when switching to alternative algorithms that require more computations, or slower when adding additional algorithms to the pipeline), and computational hardware (refresh may be slower on less powerful hardware, or faster on more powerful hardware (such as more expensive computational hardware, next generation cheap commodity hardware in the future, or more specialized hardware such as an ASIC or FPGA)). However, these numbers demonstrate that, in a typical scenario, this invention can easily allow a 5× or more improvement in refresh speeds (and hence responsiveness) compared to conventional pipelines.

The pipeline in FIG. 19 includes a number of steps, as follows:
DataProvider (1146) is a source step that provides the radiographic image to the rest of the pipeline. During real-time inspection, the DataProvider step performs framegrabs from the image acquisition hardware, marking itself out-of-date whenever new data becomes available. During offline inspection, the DataProvider step reads the data from a file.
Normalize (1148) performs offset correction and air normalization, using previous calibration data (which is read from a file).
Desparkle (1150) performs a conditional median filter. It has four strength levels:
   Strength 0: Do nothing.
   Strength 1: Apply median filter if pixel value is above a high threshold or below a low threshold.
   Strength 2: Apply median filter if strength 1 condition is met OR if pixel value is the highest or lowest in the filter's region of support.
   Strength 3: Always apply median filter.
Homography (1152, 1166) is a two-stage pan/crop and zoom operation.
Filter (1158) is a generic filtering block that in general performs a continuum of denoising and/or deblurring operations. It has a control parameter that, when positive, applies a smoothing filter (the larger the number, the more smoothing is applied) and, when negative, applies a sharpening filter (whose strength also increases as the control parameter becomes more negative). In simple embodiments, this involves simple linear filters such as a box filter, Gaussian filter, or unsharp masking. In slightly more complex embodiments, this involves nonlinear filters such as median filter or edge-preserving filters. In even more complex embodiments, this involves iterative methods such as TV denoising, wavelet denoising, or denoising by non-local means. When using iterative methods, it can be especially convenient to implement the methods as progressive steps (either synchronous or asynchronous) so that the user can still interact with the image while it progresses, but eventually the viewer will stabilize to a well-filtered result.
Simple DRM (1160) allows pointwise Dynamic Range Manipulation (DRM) adjustments. By one approach, this includes window width and level adjustment and gamma adjustment. By another approach, this includes applying a lookup table such as one produced by a global histogram equalization method.
Advanced DRM (1156) performs more sophisticated DRM adjustments that in general compress dynamic range by different amounts in different portions of the image. By one approach, this comprises contrast-limited adaptive histogram equalization (CLAHE), a common technique known in the art for adaptive dynamic range compression.
Dynamics Analysis (1154) is a preparatory stage for Advanced DRM, whereby image statistics that are slow to calculate (and rarely need to be recalculated) can be calculated early in the pipeline and cached for Advanced DRM to use (where Advanced DRM may change more frequently). In the approach where Advanced DRM is CLAHE, Dynamics Analysis computes a set of histograms and lookup tables based on the image data, which Advanced DRM then applies to effect CLAHE.
Edge Detect (1162) performs an edge detection. By one approach, this is performed using algorithms known in the art. By another approach, it uses a multi-gamma edge detection.
Composite (1164) takes the results of edge detection, simple DRM, and advanced DRM and combines them to form a single image. By one approach, composite works by taking a weighted sum of the output of its three input steps. By another approach, composite works by taking a weighted sum of the simple and advanced DRM inputs, then coloring the result according to the edge detect result.
Overlays (1168) takes the composite image and draws suitable overlays on top, such as boxes, circles, or lines used to measure region properties.

The following elaborates on additional details for a few of these steps.

Two-Stage Zoom Homography.

The pan and zoom homography steps can be efficiently implemented by two complementary pipeline steps. The first-stage zoom step crops away unnecessary data (except an optional apron), and optionally resamples the data. This step is placed near the pipeline's input. The second-stage zoom crops away the optional apron (if present) and performs any resampling that was not performed in the first stage. This step is placed near the pipeline's output. By splitting zooming into these two separate stages, all processing steps between the two stages can operate on a reduced set of data, for faster processing.

By a first approach, the first stage resampling resamples the data resolution to match the eventual display resolution for the current zoom level, and the second stage does no resampling. By a second approach, the first stage does no resampling (only cropping), and the second stage resamples the data to match the display resolution for the current zoom level. By a third approach, when the display resolution for the current zoom level is coarser than the data resolution (i.e. the data should be downsampled), the first approach is applied, and when the display resolution for the current zoom level is finer than the data resolution (i.e. the data should be upsampled), the second approach is applied. This third approach can give more accurate results than the first approach when zoomed in, and has smaller intermediate data sets than the second approach when zoomed out.

In general, the first stage will have a configurable apron of off-screen pixels, i.e. a rectangular strip of off-screen pixels that neighbor the border of the on-screen region of the image. While this apron is technically optional (note that omitting it is the same as choosing a zero-width apron), including an apron can be helpful since later processing steps may need to access neighborhoods of pixels that are themselves just barely on-screen. If an apron is used in the first stage, the second stage crops away this apron.

A subtle point is that homography stage 2 must know the apron size that homography stage 1 leaves behind. One approach to handling this is to use coupled parameters, where the same homography parameters (e.g. pan and zoom setting) must be sent to both homography stages and each does a matching calculation of apron size. Another approach is to use metadata. That is, “image data”, in addition to pixel values themselves, in general also contains metadata such as how large is the image, what is its pixel resolution, where is the image located in world spatial coordinates, etc. Homography stage 1 can embed the apron details in this metadata so that homography stage 2 can simply retrieve the required information from the metadata rather than relying on coupled parameters.

Dynamics Analysis+Advanced DRM.

There are several techniques for efficient histogram equalization. Each of these can be used regardless of whether applying global histogram equalization or adaptive histogram equalization.

One technique is to split histogram equalization into two complementary pipeline steps. The first stage is placed early in the pipeline (usually before zoom stage 1) and measures a histogram of pixel values for the image, and produces appropriate histograms and/or lookup tables as its output. The second stage is placed later in the pipeline (typically after zoom stage 1 and perhaps some additional filtering) and applies the lookup table from stage 1.

Another technique (which can be in addition to or in lieu of the above) is to include a mixing operation which mixes the equalized and unequalized signals. This mixing operation can be a standalone mixing step that takes a weighted average of two inputs (one of which is the unequalized data, one of which is the output of histogram equalization), or the mixing operation can be integrated into histogram equalization (for example, integrated into stage 2 of histogram equalization when using the two-stage technique). In this approach, adjusting the mix amount gives similar results to adjusting the contrast limit in CLAHE, but at a fraction of the computational cost.

Another technique (which can also be in addition to or in lieu of the above) is to use nonlinear histogram bin spacing, either explicitly or implicitly. With explicitly nonlinear histogram bins, we calculate a set of histogram bin thresholds according to some strategy (with logarithmic bin spacing as a common choice) then calculate the histogram on these bins. With implicitly nonlinear histogram bins, we transform the data instead, then use linear histogram bins. For example, one can apply gamma correction to the image data with an exponent of γ=0.3 then perform histogram equalization in linear space, then either apply the reciprocal gamma operation (γ=1/0.3 in this example) or take the gamma value into account in future operations that might invoke their own gamma operation.

Multi-Gamma Edge Detection.

In multi-gamma edge detection, the EdgeDetect step applies two or more different gamma adjustments (using different values for each) to the data, applies a conventional edge-detection algorithm to each gamma-adjusted image, then combines the results by an operation such as addition, addition in quadrature, or maximum. For example, for high dynamic range data, it can be useful to apply a two-gamma edge detection by using γ=0.4 and γ=2.5 and taking the point-wise maximum of the result.

### MD-Capable Pipeline

Next a pipeline is presented that is similar to FIG. 19, but that also supports Material Discrimination (MD). FIG. 20 is a flow diagram illustrating an MD-capable pipeline for digital radiography and material discrimination.

DataProvider (1172) is similar to that of FIG. 19, but the data coming from it is multi-spectral. There are a number of approaches to obtaining multi-spectral data, including dual-energy sources (such as a Varian Mi6 or Mi9 Linatron, or a switched tube source), photon-counting detectors, filter wheels, multi-layered detectors, or any combination of these. U.S. Pat. No. 8,184,769 describes some techniques that can be used in this regard, which is owned common assignee and hereby incorporated by reference in its entirety.

DR (1174) produces a digital radiograph (DR) image from the multi-spectral data. By one approach, it does this by discarding data from all but one spectrum (say, by keeping only the 6MV data from an Mi6). By another approach, the single-energy DR is a virtual single-energy image that is synthesized from more than one spectrum from the multi-spectral data.

Conditioning (1190) is a denoising step aimed to improve MD accuracy. This step is optional and may frequently be set to pass-through.

MD (1192) calculates, for every pixel, a material identifier estimate, and an MD confidence value for that estimate. Whereas DR essentially measures how attenuative a material is (but not what the material is made of), MD in contrast measures what the material is made of. By one approach, the material identifier estimate is an atomic number. By another approach, the material identifier estimate represents a soft material class index that is loosely connected to atomic number. By yet another approach, the material identifier estimate is a vector that describes the contributions to the material made by each of two or more different basis functions. By one approach, the MD confidence values comprise a binary mask. By another approach, the MD confidence values comprise a soft mask, i.e. a mask that also supports values between zero and one, zero indicating no confidence, one indicating high confidence. By another approach, the MD confidence value comprises an error estimate such as expected standard deviation. There are many reasonable approaches to performing MD calculations, including U.S. Pat. No. 8,422,826, U.S Published Patent Application No. US20130101156, or more conventional methods such as R. E. Alvarez and A. Macovski, “Energy-selective reconstructions in X-ray CT,” Phys. Med. Biol. 215, 733-744 1976, all of which are incorporated by reference in their entireties.

MCT (1194) is an input calibration table that is used by MD. Typically, it is read from a file.

MD filter (1196) denoises the MD data by using some form of smoothing filter, and produces an updated material estimate image and a potentially updated MD confidence image. By one approach, when MD confidence comprises a binary mask, this filter is a mask-aware median filter, which works as follows. If a particular pixel has a sufficient number of neighbors that are present in the binary confidence mask, that pixel is present in the output mask and its value is calculated as the median of the values of the neighboring pixels that are present in the mask. If the particular pixel does not have a sufficient number of neighbors in the binary confidence mask, then that pixel is not included in the output confidence mask. By another approach, the filter is a mask-aware linear filter, which similarly requires each pixel to have a sufficient number of in-mask neighbors in order for the output pixel to be in the mask, but this time applies a linear filter. This approach also supports soft masks, as the soft mask can be incorporated as data weights. By a third approach the filter comprises a cascade of filters—a mask-aware median, followed by a mask-aware linear filter. The mask-aware median provides outlier resilience and edge preservation, but is slow. The mask-aware linear filter is fast but sensitive to outliers and can destroy edges. By cascading the two, it can be possible to get a compromise where the combination is reasonably fast, filters away outliers, and only minimally degrades edges. In cases where particularly large filter sizes are desirable and the MD filter step is slow, it can be desirable to make MD filter run as an asynchronous step, so that when the pipeline refreshes, a previous (or unfiltered) result propagates through the pipeline, but the pipeline automatically updates when the updated MD result becomes available.

Homography (1176, 1198, 1202) is again in two stages, similar to FIG. 19. Here, however, we want to apply the same homographic transform to the DR image and the MD image (including both material estimate and MD confidence). By one approach, one could have a single homography stage 1 step with multiple inputs and multiple outputs that reads DR and MD data and transforms them both simultaneously. However, since the MD filter may be asynchronous, it can be desirable to split this into two separate homography steps. Hence a second approach (the approach used in FIG. 19) is to use two matching homography stage-1 steps (1176, 1198) that are fed the same homography parameters (typically pan and zoom).

If left uncoupled, the Edge Detect (1178), Simple DRM (1184), Dynamics Analysis (1182), and Advanced DRM (1186) are the same as FIG. 19. DRM Mix (1188) blends together Simple DRM (1184) and Advanced DRM (1186). This may be incorporated into the Composite (1200) step, or left as a separate step. In FIG. 20 it is shown as a separate step. In FIG. 19, it is integrated into the Composite step.

DR Filter (1180) is the same as “filter” in FIG. 19.

Composite (1200) is similar to that of FIG. 19, but now takes an additional input for MD. By one approach, Composite applies MD pseudocoloring (for example, see U.S. Pat. No. 8,508,545, owned by the common assignee).

Pipeline for DR and MD with Content Analysis

The pipeline from FIG. 20 can further be augmented with additional analysis tools. While there is a plethora of image processing and computer vision tools that could be incorporated, we will describe incorporating content analysis, which goes beyond mere image processing (manipulation of pixel values) and attempts to interpret the more subjective contents of the image.

At a high level, there are a number of features we can incorporate related to content-based analysis, as follows.

MD Peeling (1236) lets a user virtually peel away one layer of material to see what's hiding behind it. More specifically, it works by identifying “obfuscating” (i.e. shielding) objects and “obfuscated” (i.e. shielded or hidden) objects, then subtracts away the obfuscating material to find an estimate of the obfuscated material. For more information about MD peeling, see U.S. non-provisional patent application entitled “Method and Apparatus Pertaining to Identifying Objects of Interest in a High-Energy Image,” Ser. No. 13/676,534, invented by Kevin M. Holt, filed on 14 Nov. 2012, and the corresponding PCT application no. PCT/US13/70118, filed on 14 Nov. 2013, the disclosures of which are incorporated by reference herein in their entireties and owned by the same assignee.

Object Analysis (1238) identifies specific objects of interest within the image. For automatic object detection, there are a number of methods available in the art from the fields of computer vision, machine learning, medical computer aided diagnosis (CAD), or security imaging. In this example pipeline, Object Analysis includes an algorithm tailored to obfuscated object detection, and another algorithm tailored to anomaly detection.

Obfuscated object detection uses mechanics similar to MD Peeling, and is geared toward detecting objects that seem to be intentionally hidden, shielded, or otherwise obfuscated. For more information about obfuscated object detection and MD peeling, see U.S. non-provisional patent application entitled “Method and Apparatus Pertaining to Identifying Objects of Interest in a High-Energy Image,” Ser. No. 13/676,534, invented by Kevin M. Holt, filed on 14 Nov. 2012, and the corresponding PCT application no. PCT/US13/70118, filed on 14 Nov. 2013, the disclosures of which are incorporated by reference herein in their entireties and owned by the same assignee.

Anomaly detection looks at a database of existing images of the same object class (say, scans of the same car (by license plate), cars of the same make and model, cargo with similar manifests, machine parts of the same model number, medical implants of the same model number, or the same person's briefcase on different days), and identifies anything out of the ordinary. For additional details on anomaly detection, see a co-pending PCT patent application entitled “Apparatus and Method for Producing Anomaly Image,” PCT/US2014/028258, invented by Kevin M. Holt, filed on 14 Mar. 2014, owned by the common assignee, and a provisional application entitled “A Method for Detecting Anomalies in Cargo or Vehicle Images,” Ser. No. 61/783,285, invented by Kevin M. Holt, filed on 14 Mar. 2013, the disclosures of which are incorporated by reference herein in their entireties.

A property inspector (1242) shows detailed properties of the current inspection region, including statistical measures, object measures, and/or physics-based measures.

FIG. 21 shows a pipeline incorporating these analysis features. Most blocks are similar to FIG. 20, with a few changes.
“Homography” (1176, 1198, 1202) is omitted. This pipeline uses abridged data handling from the “Image Display” output, so homography is automatically taken care of in the abridged data handling.
“MD Peeling” (1236) is the MD peeling algorithm and is described with respect to FIG. 22. For more information on MD Peeling, see. For more information about MD peeling, see U.S. non-provisional patent application entitled “Method and Apparatus Pertaining to Identifying Objects of Interest in a High-Energy Image,” Ser. No. 13/676,534, invented by Kevin M. Holt, filed on 14 Nov. 2012, and the corresponding PCT application no. PCT/US13/70118, filed on 14 Nov. 2013, the disclosures of which are incorporated by reference herein in their entireties and owned by the same assignee.
“Object Analysis” (1238) is described in more detail in FIG. 23.
“Composite” (1232) is described further in FIG. 24.
“Property Analysis” (1240) calculates detailed information based on what region is currently selected. If an ROI is selected (by one approach, by actively clicking it, or by another approach, by simply hovering a mouse over an ROI), the ROI is used as the inspection region. If the mouse is not over an ROI, the currently visible region is the inspection region. The property analysis calculates conventional statistical measures of the inspection region such as mean or median attenuation, standard deviation, and minimum and maximum values, as well as similar statistics for MD information and for MD Peeled results. It can also be configured to produce histograms for DR, MD, and/or MD Peeling. It also calculates physics-based properties: for two-dimensional projection radiography, it calculates area density (which is derived directly from transmission value), volume density (which is estimated from the MD result), path length (by combining area density and volume density), area (by counting pixels), and volume (by combining area and path length).
“Inspector Tool” (1242) shows information calculated in Property Analysis (1240). It also shows information derived from the values calculated by Property Analysis, such as what types of materials are consistent with the MD result, and what types of materials are consistent with the MD Peeling result. It also shows additional object properties from Object Analysis (1238), such as details for why an object was marked suspicious, as well as a suspicion level. Each of the displayable items is configurable to be shown or hidden as desired.

FIG. 22 (1248) is a flow diagram illustrating part of a radiography pipeline, showing internals of the MD Peeling algorithm as a step assembly.
DR (1250), MD (1262), Composite (1268), and Object Analysis (1270) correspond to 1210, from FIG. 21, respectively.
Log (1252) takes a logarithm (or a log-like function that is modified to avoid noise-related issues in highly attenuating signals).
Detail removal (1254) is an extreme outlier-removing filter. By one approach it is a very large median filter.
DR contrast (1256) calculates a contrast between the logged DR data (from “log” step) and the output of the “detail removal” step.
“Identify BG” (1258) uses the DR contrast and logged DR value to calculate a soft mask that indicates how likely each pixel is to be part of a background (BG) object (i.e. a shielding or obfuscating object).
“DR BG” (1260) takes the BG mask from “Identify BG” and applies it to the DR data to calculate a background DR image.
“MD BG” (1264) similarly applies the BG mask to MD data to calculate a background MD image.
“Peel” (1266) removes the background from the input data. More specifically, it assumes a material of type “MD BG” in an amount related to the “DR BG” value, and subtracts that from a type and amount corresponding to the outputs of the “MD” and “log” steps.

FIG. 23 (1272) is a flow diagram illustrating part of a radiography pipeline showing internals of an Object Analysis step assembly. At a general level, the Object Analysis step assembly reads data from any sources that its internal algorithms are capable of processing (in FIG. 23, these sources comprise 1274, 1276, 1278, 1280, 1282, 1284), and calculates a set of interest maps. An interest map identifies a particular object or region of interest. Since objects and regions can be described in a variety of ways, there are many different options for describing an interest map that are known in the art. One form is a binary mask, where interesting pixels are marked 1, and uninteresting pixels are marked 0. A similar form is a soft mask, which is like a binary mask, but the level of interest for each pixel is on a continuous scale from 0 to 1 (or some other scale like 0 to 100). Another option is a region of interest (ROI). Example ROI types are box-shaped (described by location and size), circular (described by location and diameter), elliptical (described by location, major axis length, minor axis length, and angle), or polygonal (described by a list of coordinates). An interest list is a list of one or more interest maps. An interest list may simply be an array of separately stored interest maps, or it may be a structure that efficiently stores many interest maps at once, such as a label image. A label image is a type of image (known in the art) that represents a set of mutually exclusive binary masks—a pixel in a label image that has a value of 0 indicates that the pixel is not in a mask; a value of 1 indicates that the pixel is in mask 1; a value of 2 indicates that the pixel is in mask 2; and so on. The exact choice of interest map representation and interest map list representation is dependent on the application, the chosen analysis algorithms, and a number of subtle implementation decisions. A wide variety of choices are compatible with this invention.

The following discusses the steps of FIG. 23 in more detail:
Obfuscated Object Detection (1286) is a set of thresholding and morphological steps to identify hidden objects of interest based features such as their size, relative location, and/or hidden material.
Image Database (1288) holds a collection of past images of scans similar to the current scan.
Anomaly Detection (1290) compares the current image against the image database and returns any found differences.
Anomaly Post Processing (1292) removes trivial differences between the current image and the image database.
Merge Interest Map Lists (1294) takes interest map lists from the two different detection algorithms and merges them into a consolidated interest map list.

Note that the proper choice of object analysis steps is in general dependent both on application, and on the set of available algorithms. The steps in FIG. 23 are useful for cargo imaging, but in the future, new threat detection algorithms for cargo may also be incorporated into Object Analysis as they become available, by feeding their result into the Merge Interest Map Lists step. In other applications, one or both of the algorithms may be inappropriate, in which case the offending algorithm(s) can be either omitted (perhaps also omitting the Object Analysis step assembly altogether) or replaced by a more appropriate algorithm.

FIG. 24 (1302) is a flow diagram illustrating part of a radiography pipeline showing internals of a “composite” step assembly, which in essence combines results for DR, DR edge detection, MD, MD Peeling, and Object Analysis all into one output image. While there are many ways of doing this compositing, FIG. 24 (1302) is an example that has been useful in practice. Details:
“Peeling Mix” (1312) mixes the MD Filter (1308) and MD Peeling (1310) images. By one approach, by calculating a linearly weighted sum of the two. By another approach, by passing through the result of one and ignoring the other (where the choice of which to pass through is controlled by a dynamically adjustable step parameter).
“MD Pseudocolor” (1314) makes an MD pseudocolor image. This block has a parameter indicating whether to render DR-only or DR+MD. In typical usage, in DR-only mode, lightness is roughly mapped to DR value (from DRM Mix 1306), and hue and saturation are roughly constant (in the most common case, this corresponds to rendering the DR value in grayscale). In typical usage, in DR+MD mode, lightness is roughly mapped to the DR value (from DRM Mix 1306), hue is roughly mapped to material type (from Peeling Mix 1312), and saturation is mapped to material confidence (also from Peeling Mix 1312). For more information, see U.S. Pat. No. 8,508,545, which is owned by common assignee and incorporated by reference herein in its entirety.
“Edge Mix” (1316) applies edge information onto the image. By one approach, it takes the result from “MD Pseudocolor” (1314) and applies the edge image from 1304 as a semi-transparent color overlay, where transparency is a function of edge strength.
“Highlight” (1320) takes the result of “Edge Mix” (1316) and on top of that highlights interest maps obtained from object analysis (1318). The highlighting can be performed in a number of different ways, including coloring the objects of interest, reducing contrast outside the objects of interest, drawing boxes, circles, or outlines around the objects of interest, flashing the pixels in the objects of interest, or some combination of the above. For more information, see U.S. non-provisional patent application entitled “Method and Apparatus Pertaining to Identifying Objects of Interest in a High-Energy Image,” Ser. No. 13/676,534, invented by Kevin M. Holt, filed on 14 Nov. 2012, and the corresponding PCT application no. PCT/US13/70118, filed on 14 Nov. 2013, the disclosures of which are incorporated by reference herein in their entireties and owned by the same assignee.
   Note that similar approaches may also easily be used to composite many other different types of data. One important example is combining multiple imaging modalities, such as two or more of X-rays, MRI, ultrasound, infrared, mm wave, THz imaging, or visible light. Typically these can be done in several ways. By one approach, two separate modalities are fused in a pseudocolor operation (similar to how DR and MD data are fused in the MD pseudocolor step). By another approach, data from one modality is superimposed on an image from another modality (similar to how Edge data is superimposed on the DR and MD image).

### CT Pipeline

FIG. 25 illustrates a typical CT reconstruction pipeline. Typically in CT reconstruction, a use initiates a reconstruction job wherein a CT reconstruction pipeline obtains projection data and then processes that data through the whole pipeline. The result is displayed to the user, and the user might further apply different filters or analysis algorithms to the reconstructed data. However, to change any reconstruction parameters (rather than post-processing parameters), the user must initiate a new reconstruction job. Alternatively, in U.S. Pat. Pub. Application US2009/0290773, when a user changes a reconstruction parameter, the image is automatically re-reconstructed and the result is automatically displayed. For parameters that are not perfectly known ahead of time and/or cannot be perfectly calibrated, this allows a user to tweak such parameters to improve reconstruction quality, and to do so in a way that is much less cumbersome than with the conventional job-submitting approach.

There are several ways to implement the invention in US2009/0290773. One, for example, is to use a conventional pipeline (that always performs all steps) and simply re-run it each time a reconstruction parameter changes. However, by implementing invention US2009/0290773 using our new pipeline framework, reconstruction can be made much more responsive. In FIG. 25, for example, suppose that backprojection 1340 is slow, but HU scaling 1342, ring correction 1344, and reorientation 1346 are all fast; then HU scaling, ring correction, and reorientation can be adjusted by the user in a very responsive way, while updates to backprojection and its upstream steps may be slower.

Furthermore, by using abridged data, such as a zoomed CT reconstruction, or reconstruction of only particular CT slices or Multi-Planar Reformatted (MPR) images, in some cases backprojection can be made much faster for abridged data than for unabridged backprojection. By using refreshes with special treatment for abridged data, CT reconstruction can be made responsive for changes across the entire pipeline.

Another extension of this idea is iterative reconstruction, where an iterative algorithm (such as ART, SART, OSEM, etc.) makes an initial reconstruction estimate, then iteratively improves it. By making iterative reconstruction a progressive or asynchronous step with frequent transitory output, it is possible to have responsive updates even for an iterative pipeline, while at the same time showing the user a progressive display of the iterative result as it finishes. This allows a user far more power in tweaking iterative reconstruction parameters interactively, as opposed to the traditional batch job submission approach.

Another benefit of using our new pipeline framework for CT reconstruction is that CT reconstruction and CT analysis can also be coupled into one large interactive pipeline. For example, the steps in FIG. 25 (for CT reconstruction) may further feed into a set of steps similar to those of FIGS. 19-24 (for image analysis). That is, one may simultaneously tune the CT reconstruction and analyze the CT result. This gives the user the ability to adjust CT reconstruction in a way to make the images easier to analyze and, similarly, to optimize the analysis algorithms for a given reconstruction technique. And, while doing so, both types of tweaks are kept as responsive and efficient as possible.

### III. Graphical User Interfaces (GUIs)

One application of the pipelines as described above is directed to specific user interfaces.

While “steps” are specific processing operations (often mathematical, image processing, or computer vision operations) performed by the processing pipeline, “facets” are related concepts as seen from the user perspective. A facet is analogous to knobs on an old-fashioned television—a user can adjust things such as contrast, brightness, station, volume, and vertical sync; each can be adjusted independently; the result is order-independent (i.e. making a sequence of adjustments to various controls gives the same end result as making the same sequence of adjustments in a different order); the results of changing a knob are visible immediately (or at least very quickly) without any extra steps to apply the change; and the user does not necessarily need to know how each of these controls interacts with the electronics inside the apparatus or how the underlying operations are effected.

In conventional image inspection systems, a user is often presented with a variety of processing operations that can be applied, but they are typically not independent (some sequences of operations may yield disastrously bad image results); the results are not order-independent (i.e. applying operation A then operation B is typically different than applying operation B then operation A); and the user often needs some cursory understanding of what the operation does in order for the operation to be useful. In addition, once an operation has been performed, to change the effect of the operation typically requires the use of some backtracking operation, such as an “undo” button (that undoes the most recent operation), or “reload” button (that reloads the original image, undoing all operations), or “history” list (that displays all operations that have been performed and allows the user to go back to a certain state, in effect undoing the last N operations).

In contrast, our image inspection systems present the user with a set of adjustable facets. These facets give order-independent results (i.e. increasing facet A then decreasing facet B is the same as decreasing facet B then increasing facet A). They also allow independent adjustment (facet A can be adjusted without giving any consideration to facet B, and vice versa). They also isolate the user from needing to think about underlying image processing steps (i.e. they adjust “smoothness” or “contrast” facets rather than applying “box filter” or “contrast limited adaptive histogram equalization” operations). Lastly, they do not require backtracking operations to modify past adjustments—for example, a user may increase facet A from level 1 to level 2, decrease facet B by some amount, then decrease facet A back from level 2 to level 1. In effect, the user has undone the change to facet A, but without an explicit backtracking step, and without losing the changes to facet B. This is not to say that our system does not offer backtracking features—backtracking features can be very useful to a user. But, in conventional inspection systems, backtracking is often required in order to view an image several times with different mutually exclusive filters applied, whereas in our inspection system backtracking is a purely optional convenience.

While facets can be implemented in a variety of ways, they are a particularly good match with our new pipeline framework. That is, the pipeline implements a series of processing steps that are controlled by a set of processing parameters. On the user interface, the user is presented with facet controls. Each of these controls, when modified, sends new values to one or more parameters in one or more processing steps. In some cases, each facet control may map to a single processing step. In other cases, a single facet control may modify several processing steps. Additionally, some steps (such as parameterless steps) might not be associated with any facets at all. The exact mapping between facets and steps can be application-dependent. Additionally, the exact mapping between facet control values and step parameters may be application-dependent.

It can also be useful to discuss the degrees of freedom of a particular facet. For example, zoom is a particular facet that involves translating, cropping, and/or scaling an image. There are many ways an isotropic zoom (i.e. a zoom that preserves aspect ratio) can be parameterized. One is as a set of (X,Y) center coordinates and scale factor, which in total is three parameters (and three degrees of freedom). Another parameterization is upper-left (X,Y) coordinates and a scale factor, which is also three parameters (and three degrees of freedom). Another parameterization is upper-left (X,Y) coordinates and bottom-right (X,Y) coordinates, which is four parameters. Yet another parameterization is upper-left (X,Y) coordinates and a width and a height, which is four parameters. But if the aspect ratio of the image is fixed then, even though these last two parameterizations have four parameters, there are actually only three degrees of freedom to their possible values. Hence isotropic pan and zoom, regardless of which parameterization is chosen, inherently has three degrees of freedom. As another example, suppose there are two parameters, A and B, which can each vary from 0 to 100%, but neither can be non-zero at once. Collectively these two parameters span a single degree of freedom, since one could control both by a single knob that at its center position gives 0% A and 0% B, increases B as it moves to the right of center (leaving A at 0%), and increases A as it moves to the left of center (leaving B at 0%). A common example of this is filtering, where it may be desirable to make smoothing and sharpening mutually exclusive. In general, parameterization is largely an artifact of how particular steps are implemented, and a pipeline might have far more processing parameters than there are actual degrees of freedom in the viewer that it supports. This decoupling of step parameterization from facet degrees of freedom is helpful when building pipelines, since steps can be nicely factored and can work with whatever parameterization is most natural for them. The decoupling of step parameterization from facet degrees of freedom is also helpful for users since user interface controls need only be as complex as the degrees of freedom, which can often be far less complex than the underlying parameterization. As such, while in some cases the mapping from facet controls to processing steps may be trivial (i.e. just copying the control value to the parameter value), in other cases the mapping may be more complicated, such as in our example of mutually exclusive parameters.

### Radiography Viewer

FIG. 26 1348 is a diagram illustrating a first screenshot of a radiography viewer's graphical user interface. This viewer is powered by a processing pipeline, such as that shown in FIG. 19. The viewer is designed as a relatively thin skin that maps facet controls into pipeline parameters and requests pipeline output, so the aesthetics of the viewer are easily changeable.

FIG. 26 1348 shows an image display, and an image manipulation toolbar. The toolbar has a number of controls. First, a “Pin” control that holds the toolbar in place. Unpinning the toolbar enables the toolbar to be dragged around and repositioned. Next are a series of facet controls, each comprising a button for some major facet: DRM 1358, Edges 1360, Filter 1362, Advanced DRM 1364, and Sparkle Reduction 1366. These facets correspond roughly to FIG. 19's pipeline steps Simple DRM, Edge Detect, Filter, Advanced DRM, and Desparkle, respectively, though several of the facets also affect the Composite step. Additionally, the DataProvider, Normalize, and Dynamics Analysis steps in FIG. 19 are not directly controlled by any particular facet (though Dynamics Analysis is related to the Contrast Enhance facet). In general, each facet maps to at least one processing step, some facets might map to more than one processing step, and some processing steps might not be controlled by any particular facet(s). Below the buttons is a zoom control 1368 which allows zoom adjustment and also indicates current zoom level. Below that is a “Draw ROI” button 1370 and a “Quick Print” button 1372.

The facet controls work as follows: for most facets, clicking a button toggles the facet manipulation on or off. For example, from the user's perspective, toggling Edges toggles whether edges are highlighted, toggling Filter toggles whether the image is smoothed or sharpened at all, and toggling Sparkle Reduction controls whether sparkle reduction is enabled or not. Other facets, such as DRM and Zoom, cannot be toggled. With respect to the pipeline, toggling a facet works differently for different facets. Toggling either Filter or Sparkle Reduction respectively switches the Filter or Desparkle pipeline step into a pass-through mode, in which the step simply passes data directly from its input to its output without manipulating the data. Alternatively, toggling the Edges or Advanced DRM facet affects the Composite step. When the Edges facet is enabled, the Composite step reads data from its input connected to the Edge Detect step (note that this input is active) and overlays the edge data on the other image data. When the Edges facet is disabled, the Composite step does not overlay edge data, and the Composite step's Edge Detect input data is set to inactive. Similarly, when Advanced DRM is toggled on, Composite performs a linear blend of Simple and Advanced DRM results (with both inputs set to active), and when Advanced DRM is toggled off, Composite ignores the Advanced DRM result and sets its Advanced DRM input to inactive.

In addition to toggling a facet, each facet also has finer grain controls, which are also types of facets that we call sub-facets. For example, when hovering the mouse over the DRM button, several additional facet controls appear for the various sub-facets. One facet control is for display levels—a black-level facet control 1350 controls which radiographic values are displayed in black, and a white-level facet control 1352 controls which radiographic values are displayed in white. One can click either of these levels and drag it left and right to change its value; optionally (by one approach, always; by another approach, never; or by another approach, selectively, say only when holding down the control key), one can also drag it up and down to move the opposite level closer or farther away. One can also click in between these two levels and drag left and right to move both levels at once, keeping the distance between them fixed; optionally, one can also drag it up and down to change the distance between black and white levels. These two levels map to the windowing limits in the Simple DRM processing step. Another facet control 1354 is for gamma adjustment (which could also be given a more user-friendly label like brightness adjustment). This controls a gamma parameter in the Simple DRM processing step, which in turn controls the nonlinear curve that connects the windowing limits. Additionally, a DRM reset button 1356 changes the black level, white level, and gamma values all to reasonable default values.

Note that the mapping between facet control value and step parameter may be nonlinear. For instance, a slider may produce a linear value from 0.0 to 1.0, but, for example, we might want gamma values to be adjusted exponentially. In this case, we may choose gamma=GammaMin*(GammaMax/GammaMin)̂SliderValue, where “̂” means exponent, and GammaMin and GammaMax are the range of gamma values covered by the slider.

Similar to DRM, hovering over other facet buttons also displays other additional sub-facet controls. Most facets also include a “reset” button (such as 1356) which turns parameters to default values. By one approach, the default value is a parameter value that causes the corresponding processing step to do nothing (for example, in this approach the default for filtering would use parameter 0.0 on the sharpen/smooth scale, default gamma value would be 1.0, and default edge strength would be 0.0). By another approach, the default value is a predetermined parameter value (either user-configurable, or hard-coded) that tends to be useful on a wide range of images (for example, gamma=0.4, edge strength=3, black level=0%, or white level=100%). By another approach, the default value is calculated from the data itself (for example, black level=minimum data value or white level=maximum data value).

We now describe some specific sets of facets and sub-facets.

As described above, the DRM facet 1358 has sub-facets for each of Black Level 1350, White Level 1352, and Gamma 1354. Additionally, the viewer also has an extended DRM control. By one approach, since DRM cannot be disabled, the extended DRM control can be opened by clicking the DRM facet button 1358. By another approach, another button can be added to the toolbar to open the extended DRM control. The extended DRM control also shows controls for Black Level, White Level, and Gamma value, but in conjunction with an image histogram. The control shows a nonlinear histogram of intensity values, where Black Level and White Level are shown with interactive controls located at the appropriate intensity histogram bin locations.

The Edges facet 1360 has an Edge Strength sub-facet that maps to edge strength in the Edge Detect step.

The Filter facet 1362 has a Filter Preference facet that indicates a preference for sharper (but noisier) images versus less noisy (but blurrier) images. The Filter Preference facet maps to a SmoothSharpen value in the Filter step. A value of 0.0 does no filtering (i.e. just passes through data). As the slider moves to the right towards “Less Noise”, the value increases and, as it moves to the left toward “Sharper”, the value decreases. When the value is positive, the Filter step performs smoothing, where the larger the value, the more aggressive the smoothing. When the value is negative, the Filter step performs sharpening (or deblurring), where the further negative the value, the more aggressive the sharpening. In a typical configuration, the reset button returns the value to 0.0, which does no smoothing and no sharpening.

The “Advanced DRM” 1364 Facet has a “DRM Compression” facet that performs dynamic range compression. Advanced DRM in general aims to compress more detail (from a wide swath of dynamic range) into a more limited dynamic range visible on a computer screen. The DRM Compression slider affects the “DRM Mix” parameter of the Composite processing step. With 0% Compression, the Composite step ignores its input from the Advanced DRM step and just renders the output from the Simple DRM step (equivalent to toggling the Advanced DRM facet to off). With 100% Compression, the Composite step ignores the Simple DRM step and just renders data from the Advanced DRM step. With Compression values between 0 and 100%, the Composite step performs a linear mixture (i.e. weighted average) of the Simple DRM and Advanced DRM step results, using the Compress value as the Advanced DRM step weighting, and 100% minus the Compress value as the Simple DRM step weighting. In some applications, it may be desirable to label the DRM Compression value to the user as a “Contrast Enhancement” knob.

The Sparkle Reduction Facet 1366 has a Sparkle Strength sub-facet that is mapped to the strength parameter for the desparkle processing step.

Additionally, for each of these facets and sub-facets, clicking the facet button and dragging automatically shows the sub-facets, selects the primary sub-facet, and begins manipulating that sub-facet's control. This allows the user to avoid the small but non-negligible extra motion of having to first hover over a facet then go and select the appropriate control.

Additionally, other facets are controlled through other means. Pan and zoom are special types of facets. Pan is controlled by clicking and dragging the image itself. Zoom can be controlled directly by mouse scroll wheel, or by the zoom control in the toolbar. Additionally, note that multiple controls can map to the same facet. For example, zoom can be controlled by mouse scroll wheel, by a text-editable zoom control (as in FIG. 26 1348), or by zoom-in and zoom-out buttons, all of which control the same facet. As another example, DRM sub-facets can be controlled by the toolbar controls as in FIG. 26, or they can be controlled by the extended DRM control. Additionally, when multiple controls map to the same facet, changing one control effects a corresponding change in another. For example, zooming in by using the mouse scroll wheel causes the zoom display to be updated in the zoom control 1368 in FIG. 26. Similarly, changing the black or white level or gamma value in FIG. 26 induces a corresponding change in the extended DRM control, and changing the black or white level or gamma value in the extended DRM control induces a corresponding change in the corresponding facet control in FIG. 26.

In addition to facet controls, other standard user interface controls are also provided, including Acquire Data, File Open, File Save, Print, Quit, Image copy, etc. File open points the DataProvider step to read data from a file, while Acquire Data instructs the DataProvider step to read new data from a framegrab system.

FIG. 27 is a diagram illustrating a second screenshot of the radiography viewer's graphical user interface that shows adjusting edge strength control 1374 and reset 1376, where here the Edge, Filtering, and Advanced DRM facets have all been enabled, and the facet control for the Edge Strength sub-facet of the Edges facet is displayed. Compared to FIG. 26, in FIG. 27 the image edges are highlighted in blue (due to enabling the Edges facet), and additionally more structural detail is visible in all portions of the image (due to Advanced DRM).

Viewer with MD and Content Analysis

FIG. 28 is a diagram illustrating a radiography viewer's graphical user interface with material discrimination and content analysis, which uses the pipeline from FIGS. 21 to 24. This viewer contains several main facets: DR 1380, MD 1382, Edges 1384, Detection 1386, and DRM 1388. Whereas in the previous viewer sub-facets appear by hovering over a particular facet, in this viewer sub-facets are shown in panels that can be collapsed or expanded. Novice users may prefer panels to be more collapsed (i.e. fewer sub-facets shown), while more expert users may prefer panels to be more expanded (i.e. more sub-facets shown). Additionally, panels may be configured to only be viewable for certain user security levels, either by having their expand/collapse control be access controlled, or by having different facet controls for different security levels. For example, administrators could have full access to all facet controls, while non-administrators could have access to only a few select facets.

The DR facet 1380 controls whether DR data is displayed. When fully collapsed (not shown), this contains only a single toggle 1390 to control whether or not to display DR data. This facet maps to a parameter to control the intensity mapping in the MD Pseudocolor step, and also affects whether the DRM Mix input to MD Pseudocolor is active. When expanded one level (using 1392 to expand the control (also, note that 1394 collapses the control)), this shows a sub-facet for DR Filter 1396, which functions the same as the Filter facet 1362 in FIG. 26, and maps to the DR Filter pipeline step in FIG. 21. When expanded yet another level (not shown) via 1392, this shows a sharpening style sub-facet that gives a choice of deblurring kernels (unsharp masking, etc), and a smoothing style sub-facet that gives a choice of denoising kernels (box, Gaussian, median, etc). These two styles can also be linked, for example when using a single algorithm (such as a Total-Variation based algorithm for deblurring of noisy data) that performs both denoising and deblurring at once. These filter style sub-facets also map to the DR Filter step.

The MD facet 1382 controls whether MD data is displayed. When fully collapsed, this contains only a single toggle 1398 to control whether or not to display MD data. This facet maps to a parameter to control saturation in the MD Pseudocolor step, and also affects whether the Peeling Mix input to MD Pseudocolor is active. When expanded one level (as shown), this shows a sub-facet for MD Filter 1400, and when expanded another level (not shown) this shows a sub-facet for MD Filter Style, each of which is similar to DR Filter, but maps to the MD Filter step. By another approach, in the one-level expansion, an MD Confidence facet slider is also displayed, which maps to the MD step and/or MD Pseudocolor step, and controls how confident an MD determination must be in order to be displayed. Additionally, in the one-level expansion, an MD Peeling facet control can also be displayed, which, when set to on, instructs the Peeling Mix step 1312 in FIG. 24 to pass through the data from MD Peeling 1310 and ignore the data from MD Filter 1308. When set to off, this control instructs the Peeling Mix step 1312 in FIG. 24 to pass through the data from MD Filter 1308 and ignore the data from MD Peeling 1310. A separate expansion button for MD Peeling shows a panel with a sub-facet for Approximate Shielding Size, which maps to several steps in the MD Peeling step assembly FIG. 22 1248. This expanded panel also has an option for manual peeling, in which case a user can draw ROIs to explicitly inform the “identify BG” step 1258 in FIG. 22 about regions that are known to be hidden or shielding materials.

The Edges facet 1384 controls whether edges are displayed. When fully collapsed, this contains only a single toggle 1402 to control whether or not to display Edges data. This functions similarly to the Edges facet in FIG. 26 and maps to the Edge Mix step 1316 in FIG. 24. When expanded one level (as shown), this shows an Edge Display facet slider 1404 and an Edge Strength facet slider 1406; the former maps to the Edge Mix step 1316 in FIG. 24, while the latter maps to the edge strength parameter step in the Edge Detect step 1218 in FIG. 21. When expanded another level (not shown), this shows an Edge Detection Method facet, which includes a list of edge detection methods known in the art, such as Laplace, Laplacian-of-Gaussian, Sobel, Prewitt, Sobel, Roberts, and Canny, as well as custom methods such as the multi-gamma method described earlier.

The Detection Facet 1386 controls the display of automatically detected objects. When fully collapsed, it shows a Detection facet toggle 1408, which maps to the Highlight step 1320 in FIG. 24, as well as a preset dropdown 1410. Choosing a preset from this dropdown selects a set of values for various sub-facets under the Detection facet control. Expanding this one level (not shown) shows separate toggles for a Hidden Objects facet toggle (which, when set to off, instructs the Merge Interest Map Lists step 1294 in FIG. 23 to ignore the Obfuscated Object Detection step 1286's result), and an Anomalies facet toggle (which, when set to off, instructs the Merge Interest Map Lists step 1294 in FIG. 23 to ignore the Anomaly Post Processing 1292 result in FIG. 23). Expanding this one level further shows sub-facets related to each algorithm. For example, under Hidden Objects, it shows facets for minimum shielding amount, minimum shielding size, minimum object size, and similar parameters as described in patent application 12-035, and may also map to steps in the MD Peeling step assembly 1248 in FIG. 22. Under Anomaly detection, an Anomaly Tolerance facet is shown, which maps to the Anomaly Detection and Anomaly Post-Processing steps and controls the sensitivity of the algorithm, i.e. the likelihood of the anomaly detection algorithm to classify a borderline result as anomalous.

The DRM facet control 1388 is technically a sub-facet of DR, and is only enabled when the DR facet toggle 1390 is on. The DRM facet control controls the Simple DRM, Advanced DRM, and DRM Mix steps at once, with a number of facets. It allows black level 1414 and white level 1418 adjustment, gamma 1412 adjustment, and several other nonlinear transformations, all of which map to the Simple DRM step. It also has a Dynamic Range Compression facet 1416, which maps to the Advanced DRM step. Right clicking the Dynamic Range Compression facet also brings up a pop-up menu to adjust the Dynamic Range Compression Method facet, which displays a list of algorithms to choose from, including other adaptive DRM methods as alternatives to CLAHE. This DRM Compression Method facet also maps to the Advanced DRM step. Additionally, the DRM facet control shows a histogram of image pixel values 1420, which provides context for setting the black level and white levels.

Additionally, the interface has some components that do not necessarily support user-modification of any facets, but provide more information to the user about the image. An MD color legend 1422 shows what colors are used to represent different materials (and describes the effect of the MD Pseudocolor step 1314 in FIG. 24). Additionally, a property inspector panel 1424 gives a variety of information calculated about the current inspection view (as described earlier).

Additional Features.

The interfaces described here can have many additional components. One example is a preset dropdown, which adjusts many facets at once. Depending on the application, the list of presets may be preconfigured, user-editable, or editable only by an administrator. Each facet may also have hardware control, for example a set of physical buttons to toggle main facets and a set of sliders and knobs to control sub-facets. Such a mechanical interface could be standalone, so that other interfaces (such as a mouse or keyboard) are not required. Or it could operate in tandem with a computer display, whereby moving a physical slider or knob would move the on-screen knob. Furthermore, if motorized sliders or knobs are available, moving the slider or knob graphic control on a computer screen with a mouse would cause the corresponding motorized slider to also move. It might also be desirable to provide control of a few commonly used facets through a mechanical controller, with the full array of facet controls still available in a software graphic user interface if needed.

Some portions of the above description describe the embodiments in terms of algorithmic descriptions and processes, e.g., as with the description within FIGS. 1-28. These operations (e.g., the processes described above), while described functionally, computationally, or logically, are understood to be implemented by computer programs or equivalent electrical circuits, microcode, or the like. The computer programs are typically embedded as instructions that can be stored on a tangible computer readable storage medium (e.g., flash drive disk, or memory) and are executable by a processor, for example, as described in FIGS. 1-28. Furthermore, it has also proven convenient at times to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one or more than one. The term “plurality,” as used herein, is defined as two or more than two. The term “another,” as used herein, is defined as at least a second or more.

The invention can be implemented in numerous ways, including as a process, an apparatus, and a system. In this specification, these implementations, or any other form that the invention may take, may be referred to as techniques. In general, the order of the connections of disclosed apparatus may be altered within the scope of the invention.

The present invention has been described in particular detail with respect to some possible embodiments. Those skilled in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

An ordinary artisan should require no additional explanation in developing the methods and systems described herein but may nevertheless find some possibly helpful guidance in the preparation of these methods and systems by examining standard reference works in the relevant art.

These and other changes can be made to the invention in light of the above detailed description. In general, in the following claims, the terms used should not be construed to limit the invention to the specific embodiments disclosed in the specification and the claims, but should be construed to include all methods and systems that operate under the claims set forth herein below. Accordingly, the invention is not limited by the invention, but instead its scope is to be determined entirely by the following claims.

What is claimed and desired to be secured by Letters Patent of the United States is:

1. A method for data processing, comprising:
performing an operation by dividing the operation into a plurality of processing steps;
creating a pipeline by arranging the plurality of processing steps into a pipeline structure, the plurality of processing steps selected to accomplish the operation;
responding to an event by determining a subset of steps from the plurality of processing steps that are relevant to the event; and
executing the pipeline by running processing steps in the pipeline structure that are relevant to the event.

2. The method of claim 1, wherein the responding to the event comprises responding to a triggering event.

3. The method of claim 2, wherein the triggering event comprises an arrival of a new input, an update from a background job, a timer going off, a previous calculation finishing, engine idle time becoming available, or a request for one output.

4. The method of claim 1, wherein the arranging of the pipeline structure is defined by establishing connections between the plurality processing steps.

5. The method of claim 1, wherein arranging the plurality of steps into a pipeline structure by connecting the plurality of processing steps nonlinearly.

6. The method of claim 1, wherein arranging the plurality of steps into a pipeline structure by connecting the plurality of processing steps to form a directed acyclic graph (DAG).

7. The method of claim 1, wherein arranging the plurality of steps into a pipeline structure by connecting the plurality of processing steps linearly.

8. The method of claim 1, wherein the pipeline has one or more inputs and one or more outputs.

9. The method of claim 1, wherein the subset of steps relevant to the event comprises one or more directly affected steps, zero or more indirectly affected steps, and zero or more unaffected steps, each step having at least one attribute and at least one step status.

10. The method of claim 9 wherein the step attribute comprises a determination as to whether a step is up-to-date or out-of-date.

11. The method of claim 9, wherein the zero or more indirectly affected steps are connected downstream relative to the one or more directly affected steps.

12. The method of claim 9, wherein the at least one step attribute comprises progressive, synchronous, asynchronous, greedy and thrifty.

13. The method of claim 9, wherein the step status comprises unabridged clean and dirty, abridged clean and dirty, output stable and output transitory, and fresh output.

14. The method of claim 9, wherein the at least one step status comprises a plurality of states, each state serving as a status identifier associated with a particular step at a particular time.

15. The method of claim 1, further comprising one or more processing steps related to Zoom, Dynamic Range Manipulation, Filtering, Adaptive Histogram Equalization, Material Discrimination, Material Discrimination Peeling, Edge Manipulation, Tone Mapping, Homography, Object Analysis, and Property Analysis.

16. The method of claim 1, further comprising one or more facets related to the plurality of processing steps, the one or more facets including Zoom, Dynamic Range Manipulation, Filtering, Adaptive Histogram Equalization, Material Discrimination, Material Discrimination Peeling, Edge Manipulation, Tone Mapping, Homography, Object Analysis, and Property Analysis.

17. An electronically implemented method for data processing, comprising:
providing a plurality of processing steps; and
calculating at least one output from a pipeline;
wherein the calculating at least one output comprises
determining zero or more steps to skip;
determining zero or more steps to use a cache value;
determining zero or more steps to execute; and
running the steps determined to execute such that all of the relevant out-of-date steps are executed.

18. The method of claim 17, wherein the data processing comprises X-ray imaging data.

19. The method of claim 17, wherein the pipeline comprises a nonlinear pipeline.

20. The method of claim 19, wherein the pipeline comprises a directed acyclic graph (DAG).

21. The method of claim 19, wherein the pipeline has a plurality of inputs.

22. The method of claim 19, wherein the pipeline has a plurality of outputs.

23. The method of claim 19, wherein the pipeline has a cyclic graph.

24. The method of claim 17, wherein the pipeline comprises a linear pipeline.

25. The method of claim 17, wherein changing a parameter for a step causes that step and all downstream steps to be out-of-date.

26. The method of claim 17, wherein changing a parameter for a step causes that step and relevant downstream steps to be out-of-date.

27. The method of claim 25, where there is a many-to-many mapping between the facet adjustments and a set of processing parameters for a pipeline.

28. The method of claim 17, wherein running the steps determined to execute comprises running only steps that are out-of-date.

29. The method of claim 17, wherein running the steps determined to execute comprises running only relevant steps that are out-of-date.

30. The method of claim 17, wherein running the steps determined to execute comprises, for a step that is out-of-date whose input comes from a step that is up-to-date, using a cached value for the step that is up-to-date instead of running the step that is up-to-date.

31. The method of claim 17, wherein the calculating at least one output comprises waiting for any step in the pipeline to become out-of-date before calculating the output.

32. The method of claim 17, wherein the calculating at least one output comprises calculating the output in response to a new user input.

33. The method of claim 30, wherein the calculating at least one output comprises calculating the output in response to a new user input.

34. The method of claim 17, wherein the calculating at least one output comprises calculating the output after a predetermined amount of time has elapsed.

35. The method of claim 17, further comprising:
when idle, performing a background data-push from one or more changed steps.

36. The method of claim 17, wherein running the steps in calculating at least one output comprises:
a recursive data-pull, the recursive data-pull including requesting output data from at least one step corresponding to the at least one output, the requesting output data from a particular step including:
if the particular step has an up-to-date cache, returning the cached data;
if the particular step does not have an up-to-date cache, calculating new data by:
requesting output data from each step whose output is an input to the particular step;
calculating new output data for the particular step, using the requested input data;
if caching is enabled for the particular step, caching the new output data for the particular step, and returning the new output data.

37. The method of claim 17, wherein running the steps comprises, if one or more steps are finished, marking the one or more finished steps as up-to-date.

38. The method of claim 17, wherein the calculating at least one output comprises calculating the output in response to a background process notification.

39. The method of claim 34, wherein the calculating at least one output comprises calculating the output in response to a background process notification.

40. The method of claim 17, wherein the calculating at least one output comprises calculating the output in response to a background process notification.

41. The method of claim 17, wherein the calculating at least one output comprises running a background job.

42. The method of claim 17, wherein one or more processing steps produce intermediate results prior to a final result.

43. The method of claim 37, wherein one or more processing steps produce intermediate results prior to a final result.

44. A computer implemented graphical user interface, comprising:
receiving an image for inspection by the graphical user interface; and
applying one or more order-independent facet controls to the image for inspecting the image, the one more order-independent facet controls permit each order-independent facet control to apply the image at any time in no particular order.

45. The method of claim 44, wherein the set of order-independent facet controls comprises zero or more facet controls corresponding to a Zoom facet, zero or more facet controls corresponding to a Dynamic Range Manipulation facet, and one or more facet controls corresponding to one or more additional facets.
